(19) United States
(12) Patent Application Publication
(10) Pub. No.: US 2024/0406820 A1
(43) Pub. Date: Dec. 5, 2024

(54) SOURCE AND TARGET NODE COORDINATION FOR MEASUREMENT CONFIGURATION IN PSCELL CHANGE

(71) Applicant: Nokia Technologies Oy, Espoo (FI)

(72) Inventors: Jedrzej STANCZAK, Wroclaw (PL); Ahmad AWADA, Munich (DE); Krzysztof KORDYBACH, Wroclaw (PL)

(21) Appl. No.: 18/701,578

(22) PCT Filed: Oct. 20, 2021
(86) PCT No.: PCT/EP2021/079138

§ 371 Date: Apr. 15, 2024

(51) Int. Cl. H04W 36/00

(52) U.S. Cl. CPC H04W 36/0085

(57) ABSTRACT

Techniques for coordination between nodes for measurement configuration in a Primary Secondary Cell Group (SCG) Cell (PSCell) change procedure in cellular wireless communication networks are provided. For example, a method for a Primary Secondary Cell Group (SCG) Cell (PSCell) change procedure is provided. The method comprises: sending, from a master node (MN) to a target secondary node (T-SN), a first message (e.g., an SN Addition Request message) including configuration information based on which the T-SN determines whether to provide a full configuration or a delta configuration for measurement-related information for one or more candidate target PSCells acknowledged by the T-SN; and receiving, at the MN from the T-SN in accordance with the configuration information, a second message (e.g., an SN Addition Request Acknowledge message) including the full configuration or the delta configuration for measurement-related information for the one or more candidate target PSCells acknowledged by the T-SN.

### FIELD

The present disclosure is related to wireless communication, and more specifically, to a method for Primary Secondary Cell Group (SCG) Cell (PSCell) change procedure in cellular wireless communication networks. More specifically, the present disclosure is related to a coordination between nodes for measurement configuration in conditional PSCell change (CPC) procedure.

### BACKGROUND

With the tremendous growth in the number of connected devices and the rapid increase in user/network traffic volume, various efforts have been made to improve different aspects of wireless communication for cellular wireless communication systems, such as fifth generation (5G) New Radio (NR), by improving data rate, latency, reliability and mobility.

The 5G NR system is designed to provide flexibility and configurability to optimize the network services and types, accommodating various use cases such as enhanced Mobile Broadband (eMBB), massive Machine-Type Communication (mMTC), and Ultra-Reliable and Low-Latency Communication (URLLC).

However, as the demand for radio access continues to increase, there exists a need for further improvements in the art.

### SUMMARY

The present disclosure is related to a method for a CPC procedure in a cellular wireless communication network.

According to a first aspect of the present disclosure, a method for a Primary Secondary Cell Group (SCG) Cell (PSCell) change procedure is provided. The method according to the first aspect comprises sending, from a master node (MN) to a target secondary node (T-SN), a first message (e.g., an SN Addition Request message) including configuration information based on which the T-SN determines whether to provide a full configuration or a delta configuration for measurement-related information for one or more candidate target PSCells acknowledged by the T-SN; and receiving, at the MN from the T-SN in accordance with the configuration information, a second message (e.g., an SN Addition Request Acknowledge message) including the full configuration or the delta configuration for measurement-related information for the one or more candidate target PSCells acknowledged by the T-SN. The method may be performed by the MN.

According to a second aspect of the present disclosure, another method for a Primary Secondary Cell Group (SCG) Cell (PSCell) change procedure is provided. The method according to the second aspect comprises receiving, at a target secondary node (T-SN) from a master node (MN), a first message (e.g., an SN Addition Request message) including configuration information based on which the T-SN determines whether to provide a full configuration or a delta configuration for measurement-related information for one or more candidate target PSCells acknowledged by the T-SN; and sending, from the T-SN to the MN in accordance with the configuration information, a second message (e.g., an SN Addition Request Acknowledge message) including the full configuration or the delta configuration for measurement-related information for the one or more candidate target PSCells acknowledged by the T-SN. The method may be performed by the T-SN.

According to a third aspect of the present disclosure, yet another method for a Primary Secondary Cell Group (SCG) Cell (PSCell) change procedure is provided. The method according to the third aspect comprises sending, from a source secondary node (S-SN) to a master node (MN), a third message (e.g., an SN Change Required message) including a list of PSCells selected by the S-SN, wherein the third message including configuration information based on which a target secondary node (T-SN) determines whether to provide a full configuration or a delta configuration for measurement-related information for one or more candidate target PSCells acknowledged by the T-SN and wherein the one or more candidate target PSCells being at least a subset of the list of PSCells; receiving, at the S-SN from the MN, information on the one or more target PSCells acknowledged by the T-SN; and sending, from the S-SN to the MN, an updated full configuration for measurement-related information or an acknowledgment. The method may be performed by the S-SN.

According to a fourth aspect of the present disclosure, a master node (MN) for a Primary Secondary Cell Group (SCG) Cell (PSCell) change procedure is provided. The MN comprises one or more non-transitory computer-readable media containing computer-executable instructions embodied therein; and at least one processor coupled to the one or more non-transitory computer-readable media. The at least one processor is configured to execute the computer-executable instructions to send, to a target secondary node (T-SN), a first message (e.g., an SN Addition Request message) including configuration information based on which the T-SN determines whether to provide a full configuration or a delta configuration for measurement-related information for one or more candidate target PSCells acknowledged by the T-SN; and receive, from the T-SN in accordance with the configuration information, a second message (e.g., an SN Addition Request Acknowledge message) including the full configuration or the delta configuration for measurement-related information for the one or more candidate target PSCells acknowledged by the T-SN.

According to a fifth aspect of the present disclosure, a target secondary node (T-SN) for a Primary Secondary Cell Group (SCG) Cell (PSCell) change procedure is provided. The T-SN comprises one or more non-transitory computer-readable media containing computer-executable instructions embodied therein; and at least one processor coupled to the one or more non-transitory computer-readable media. The at least one processor is configured to execute the computer-executable instructions to receive, from a master node (MN), a first message (e.g., an SN Addition Request message) including configuration information based on which the T-SN determines whether to provide a full configuration or a delta configuration for measurement-related information for one or more candidate target PSCells acknowledged by the T-SN; and send, to the MN in accordance with the configuration information, a second message (e.g., an SN Addition Request Acknowledge message) including the full configuration or the delta configuration for measurement-related information for the one or more candidate target PSCells acknowledged by the T-SN.

According to a sixth aspect of the present disclosure, a source secondary node (S-SN) for a Primary Secondary Cell Group (SCG) Cell (PSCell) change procedure is provided. The S-SN comprises one or more non-transitory computer-readable media containing computer-executable instructions embodied therein; and at least one processor coupled to the one or more non-transitory computer-readable media. The at least one processor configured to execute the computer-executable instructions to send, to a master node (MN), a third message (e.g., an SN Change Required message) including a list of PSCells selected by the S-SN, wherein the third message including configuration information based on which a target secondary node (T-SN) determines whether to provide a full configuration or a delta configuration for measurement-related information for one or more candidate target PSCells acknowledged by the T-SN and wherein the one or more candidate target PSCells being at least a subset of the list of PSCells; receive, from the MN, information on the one or more target PSCells acknowledged by the T-SN; and send, to the MN, an updated full configuration for measurement-related information or an acknowledgment.

According to seventh aspect of the present disclosure, a system for a Primary Secondary Cell Group (SCG) Cell (PSCell) change procedure is provided. The system comprises the master node (MN) according to the fourth aspect of the present disclosure; and at least one user equipment (UE) for communication with the MN.

The above-noted aspects and features may be implemented in systems, apparatuses, methods, articles and/or non-transitory computer-readable media depending on the desired configuration. The present disclosure may be implemented in and/or used with a number of different types of devices, including but not limited to cellular phones, tablet computers, wearable computing devices, portable media players, and any of various other computing devices.

This summary is intended to provide a brief overview of some of the aspects and features according to the present disclosure. Accordingly, it will be appreciated that the above-described features are merely examples and should not be construed to narrow the scope of the present disclosure in any way. Other features, aspects, and advantages of the present disclosure will become apparent from the following detailed description, drawings and claims.

### BRIEF DESCRIPTION OF THE DRAWINGS

A better understanding of the present disclosure can be obtained when the following detailed description of various embodiments is considered in conjunction with the following drawings, in which:

FIG. 1A illustrates an example signaling flow for SN-initiated Secondary Node Change for the EN-DC case according to 3GPP TS 37.340;

FIG. 1B illustrates an example signaling flow for the MN-initiated Secondary Node Addition for the MR-DC with 5GC case according to 3GPP TS 37.340;

FIG. 1C illustrates an example signaling flow for the SN-initiated Secondary Node Change for the MR-DC with 5GC case according to 3GPP TS 37.340;

FIG. 2 illustrates a simplified example signaling flow for SN-initiated PSCell change procedure according to another implementation;

FIG. 3 illustrates a flow chart of a method for a Conditional Primary Secondary Cell Group (SCG) Cell (PSCell) change (CPC) procedure according to an example implementation of the present disclosure;

FIG. 4 illustrates a simplified example signaling flow of a method for the Conditional Primary Secondary Cell Group (SCG) Cell (PSCell) change (CPC) procedure with SN-initiated indicator according to an example implementation of the present disclosure;

FIG. 5 illustrates a simplified example signaling flow of a method for the Conditional Primary Secondary Cell Group (SCG) Cell (PSCell) change (CPC) procedure with full configuration information according to an example implementation of the present disclosure;

FIG. 6 illustrates a simplified example signaling flow of a method for the Conditional Primary Secondary Cell Group (SCG) Cell (PSCell) change (CPC) procedure with parameter indicator for full configuration information according to an example implementation of the present disclosure; and

FIG. 7 illustrates a block diagram of a node for wireless communication according to an example implementation of the present disclosure.

### DETAILED DESCRIPTION

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purpose of consistency and case of understanding, like features may be identified (although, in some examples, not illustrated) by the same numerals in the drawings. However, the features in different implementations may be differed in other respects and shall not be narrowly confined to what is illustrated in the drawings.

The phrases “in one implementation,” or “in some implementations,” may each refer to one or more of the same or different implementations. The term “coupled” is defined as connected whether directly or indirectly through intervening components and is not necessarily limited to physical connections. The term “comprising” means “including, but not necessarily limited to” and specifically indicates open-ended inclusion or membership in the so-described combination, group, series or equivalent. The expression “at least one of A, B and C” or “at least one of the following: A, B and C” means “only A, or only B, or only C, or any combination of A, B and C.”

The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details such as functional entities, techniques, protocols, and standards are set forth for providing an understanding of the present disclosure. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software or a combination of software and hardware. Disclosed functions may correspond to modules which may be software, hardware, firmware, or any combination thereof.

A software implementation may include computer-executable instructions stored on a computer-readable medium such as memory or other types of storage devices. The computer-readable medium may be non-transitory. One or more microprocessors or general-purpose computers with communication processing capability may be programmed with corresponding executable instructions and perform the disclosed network function(s) or algorithm(s).

The microprocessors or general-purpose computers may include Applications Specific Integrated Circuitry (ASIC), programmable logic arrays, and/or using one or more Digital Signal Processor (DSPs). Although some of the disclosed implementations are oriented to software installed and executing on computer hardware, alternative implementations implemented as firmware or as hardware or as a combination of hardware and software are well within the scope of the present disclosure. The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long Term Evolution (LTE) system, a LTE-Advanced (LTE-A) system, a LTE-Advanced Pro system, or a 5G NR Radio Access Network (RAN) typically includes at least one base station (BS), at least one user equipment (UE), and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

The RAN may also be disaggregated into blocks, including a Radio Unit (RU), a Distributed Unit (DU) and a Centralized Unit (CU), forming an Open RAN environment. The RU is where the radio frequency signals are transmitted, received, amplified and digitized. The RU is located near, or integrated into, the antenna. The DU and CU are the computation parts of the at least one BS, sending the digitalized radio signal into the network. The DU is physically located at or near the RU whereas the CU can be located nearer the Core. In the Open RAN environment, interfaces within the RAN are defined, including, for example, for fronthaul between the RU and the DU, midhaul between the DU and the CU, and backhaul connecting the RAN to the Core. Beyond that, the protocols and interfaces between the building blocks (radios, hardware and software) in the RAN are open. The Open RAN environment may further include a RAN Intelligent Controller (RIC) to add programmability to the RAN.

An implementation of the RAN in a more open and flexible architecture virtualizes network functions in software platforms based on general-purpose processor. Such an implementation is referred to as Cloud RAN or virtualized RAN (vRAN). The vRAN utilizing open interfaces may be one component of the Open RAN. Cloud RAN virtualizes and splits functions into at least two separated functions, including virtualized Distributed Unit (vDU) and virtualized Centralized Unit (vCU).

An UE may include but is not limited to a mobile station, a mobile terminal or device, or an user communication radio terminal. The UE may be a portable radio equipment that includes but is not limited to a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include but is not limited to a node B (NB) in the UMTS, an evolved node B (eNB) in LTE or LTE-A, a radio network controller (RNC) in UMTS, a BS controller (BSC) in the GSM/GERAN, a next generation (ng)-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using a plurality of cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the downlink (DL) and optionally uplink (UL) resources to at least one UE within its radio coverage for DL and optionally UL packet transmissions. The BS can communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

The following description may provide further details on implementations of the gNB, the RAN and the UE.

A gNB comprises a node providing NR user plane and control plane protocol terminations towards the UE, and connected via the NG interface to the 5GC as described in e.g. section 3.2 of 3GPP TS 38.300 V16.6.0, which is incorporated herein by reference.

A gNB Central Unit (gNB-CU) comprises a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises a logical node hosting RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises a logical node hosting the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

A gNB-CU-User Plane (gNB-CU-UP) comprises a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU as described in e.g. section 3.1 of 3GPP TS 38.401 V16.6.0, which is incorporated herein by reference.

The following different functional splits (referred to as options) between the central and distributed unit are possible:

Option 1 (1A-like split): The function split in this option is similar as 1A architecture in DC. RRC is in the central unit. PDCP, RLC, MAC, physical layer and RF are in the distributed unit.

Option 2 (3C-like split): The function split in this option is similar as 3C architecture in DC. RRC, PDCP are in the central unit. RLC, MAC, physical layer and RF are in the distributed unit.

Option 3 (intra RLC split): Low RLC (partial function of RLC), MAC, physical layer and RF are in the distributed unit. PDCP and high RLC (the other partial function of RLC) are in the central unit.

Option 4 (RLC-MAC split): MAC, physical layer and RF are in the distributed unit. PDCP and RLC are in the central unit.

Other possible implementations are described in e.g. section 11 of 3GPP TR 38.801 V14.0.0, which is incorporated herein by reference.

A gNB supports different protocol layers such as Layer 1 (L1)—physical layer offering to Medium Access Control (MAC) sublayer transport channels, Layer 2 (L2) of the NR, which is split into the following sublayers: the MAC sublayer offering to Radio Link Control (RLC) sublayer logical channels, the RLC sublayer offerering to Packet Data Convergence Protocol (PDCP) sublayer RLC channels, the PDCP offerering to the Service Data Adaptation Protocol (SDAP) sublayer radio bearers, and the SDAP sublayer offering to 5GC QoS flows, and Layer 3 (L3) including Radio Resource Control (RRC) as described e.g. in section 6 of 3GPP TS 38.300 V16.6.0, which is incorporated herein by reference.

A RAN (Radio Access Network) node or network node such as a gNB, base station, gNB CU or gNB DU or parts thereof may be implemented using an apparatus with at least one processor and/or at least one memory (with computer-readable instructions (computer program)) configured to support and/or provision and/or processing of CU and/or DU related functionality and/or features, and/or at least one protocol (sub-)layer of a RAN (Radio Access Network), e.g. layer 2 and/or layer 3.

The gNB CU and gNB DU parts may be co-located or physically separated. gNB DU may even be split further into two parts, one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof.

A gNB-DU supports one or multiple cells, and could thus serve as a serving cell for user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, such as RRC connection to the RAN. A UE is configured to generate a message (e.g., including a cell ID) to be transmitted via radio towards a RAN (e.g., to reach and communicate with a serving cell). A UE may generate and transmit and receive RRC messages or RRC PDUs (Packet Data Units). An RRC message may include a header and payload, and potentially a footer.

The UE may have different states as described e.g. in sections 4.2 and 4.4 of 3GPP TS 38.331 V16.5.0, which are incorporated herein by reference.

A UE is either in RRC_CONNECTED state or in RRC_INACTIVE state when an RRC connection has been established. In RRC_CONNECTED state the UE may: store the AS context; transfer of unicast data to/from UE; monitor control channels associated with the shared data channel to determine if data is scheduled for the UE; provide channel quality and feedback information; perform neighboring cell measurements and measurement reporting.

The RRC protocol includes the following main functions: RRC connection control; measurement configuration and reporting; establishment/modification/release of measurement configuration (e.g., intra-frequency, inter-frequency and inter-RAT measurements); setup and release of measurement gaps; measurement reporting.

A network node providing a Central Unit functionality and/or L3 processing may be considered the part of the master node, which is providing RRC Reconfiguration Messages to the user equipment by support and/or provision and/or processing of CU related functionality and/or features, and/or at least one protocol (sub-)layer of a RAN (Radio Access Network), such as Layer 3. A L3 message may be a Radio Resource Control message. The network node could be implemented using hardware and/or software, and has interfaces to other nodes, such as S-SN and/or T-SN for providing one or more of the above communications or method steps. As previously described, the frame structure for NR supports flexible configurations for accommodating various next generation (e.g., 5G) communication requirements such as Enhanced Mobile Broadband (eMBB), Massive Machine Type Communication (mMTC), and Ultra-Reliable and Low-Latency Communication (URLLC), while fulfilling high reliability, high data rate and low latency requirements. The Orthogonal Frequency-Division Multiplexing (OFDM) technology in the 3rd Generation Partnership Project (3GPP) may serve as a baseline for a NR waveform. The scalable OFDM numerology such as adaptive sub-carrier spacing, channel bandwidth, and Cyclic Prefix (CP) may also be used.

Two coding schemes are considered for NR, specifically Low-Density Parity-Check (LDPC) code and Polar Code. The coding scheme adaption may be configured based on channel conditions and/or service applications.

When a transmission time interval (TTI) of a single NR frame includes DL transmission data, a guard period, and UL transmission data, the respective portions of the DL transmission data, the guard period, and the UL transmission data may be configured based on the network dynamics of NR. SL resources may also be provided in a NR frame to support ProSe services or V2X services.

Examples of some terms used in the present disclosure are given below.

Primary Cell (PCell): PCell is the master cell group (MCG) cell, operating on the primary frequency, in which the UE either performs the initial connection establishment procedure or initiates the connection re-establishment procedure. PCell is the special cell (SpCell) of the MCG.

Primary SCG Cell (PSCell): For dual connectivity (DC) operation, PSCell is the secondary cell group (SCG) cell in which the UE performs random access when performing the reconfiguration with sync procedure. PSCell is the SpCell of the SCG. In some implementations, the term PSCell may refer to a Primary Secondary Cell. The term “Primary SCG Cell” and the term “Primary Secondary Cell” may be used interchangeably in the present disclosure.

Special Cell (SpCell): For DC operation the term Special Cell (SpCell) refers to the PCell of the MCG or the PSCell of the SCG, otherwise the term Special Cell refers to the PCell.

Secondary Cell (SCell): For an UE configured with carrier aggregation (CA), SCell is a cell providing additional radio resources on top of Special Cell.

Serving Cell: For an UE in RRC CONNECTED not configured with CA/DC there is only one serving cell comprising the primary cell. For an UE in RRC CONNECTED configured with CA/DC the term “serving cells” is used to denote the set of cells comprising the Special Cell(s) and all secondary cells.

Master Cell Group (MCG): in Multi Radio Dual Connectivity (MR-DC), MCG is a group of serving cells associated with the Master Node, comprising the SpCell (PCell) and optionally one or more SCells.

Master Node (MN): in MR-DC, MN is the radio access node that provides the control plane connection to the core network. It may be a Master eNB (in E-UTRA-NR Dual Connectivity, EN-DC), a Master ng-eNB (in NG-RAN E-UTRA-NR Dual Connectivity, NGEN-DC) or a Master gNB (in NR-NR Dual Connectivity, NR-DC, and NR-E-UTRA Dual Connectivity, NE-DC).

Secondary Cell Group (SCG): in MR-DC, SCG is a group of serving cells associated with the Secondary Node, comprising of the SpCell (PSCell) and optionally one or more SCells.

Secondary Node (SN): in MR-DC, SN is the radio access node, with no control plane connection to the core network, providing additional resources to the UE. It may be an en-gNB (in EN-DC), a Secondary ng-eNB (in NE-DC) or a Secondary gNB (in NR-DC and NGEN-DC).

In a wireless communication network, such as E-UTRAN, one of the main causes of handover (HO) failure is an UE not receiving a Handover Command message from a source base station (e.g., a source eNB or a source gNB) or a serving base station (e.g., a serving eNB or a serving gNB). A conventional handover procedure is usually triggered by a measurement report from the UE. For example, when the serving cell's quality (e.g., signal strength and/or service quality) is below a preconfigured threshold and a neighboring cell's quality (e.g., signal strength and/or service quality) is above a preconfigured threshold, the UE may send a measurement report to the source base station under the serving cell based on the received measurement configurations. Upon receiving the measurement report, the source base station may send a Handover Request message to multiple target base stations (e.g., eNB or gNB) for admission control, and receive Handover Acknowledgement messages from the target base stations. The source base station may select and send a Handover Command message (which may be included in a Handover Acknowledgement message from one of the target base stations) to the UE so that the UE can connect to the target cell.

The success of the overall handover procedure depends on several factors. One of the factors is that the serving cell quality does not drop rapidly within a short period of time, which may be dominated by the latency of the backhaul (e.g., for X2/Xn/Xx interface), the processing time of target base stations, and the signaling transmission time. Unfortunately, in a real-world situation, the serving cell quality can drop very quickly within a short period of time, and the UE may not successfully receive the Handover Command message before the serving cell quality drops significantly. As a result, the UE may detect a radio link failure. Consequently, in response to the detected radio link failure, the UE may initiate a radio resource control (RRC) Connection Re-establishment procedure, which in turn leads to a considerable amount of service interruption time. In a next generation wireless network (e.g., a 5G NR network), with massive antenna beamforming in higher frequency bands, a serving cell quality may degrade even faster, especially when narrow beams are used to serve the UE. Blockage is another unavoidable problem in NR deployments.

The 3GPP has introduced the concept of conditional handover (CHO) to improve reliability of the overall handover procedure. The CHO procedure may be viewed as a supplementary procedure to the conventional handover procedure to help reduce the handover failure rate.

To execute a conditional reconfiguration command, an UE may evaluate the triggering condition(s) associated with the conditional reconfiguration command to determine whether one or more triggering conditions (or executions conditions) for the conditional reconfiguration command is met. When the UE determines that a triggering condition is satisfied, the UE may apply the corresponding conditional reconfiguration command to connect to the target cell. Existing measurement events (e.g., A3 and A5) may be used for determining whether a triggering condition of a conditional reconfiguration command is satisfied.

CHO may help to improve reliability of the overall handover procedure. Applying concepts similar to CHO may also be beneficial to a PSCell addition procedure, a PSCell change procedure, an SN addition procedure, or an SN change procedure for MR-DC mode, because preparation between the MN and the SN and RRC signaling to add the SN may finish in advance.

An UE may behave differently when concepts of CHO (or conditional configuration) are applied to a normal HO (e.g., PCell change) procedure or a PSCell addition/change (or SN addition/change) procedure. For example, the UE may not need to release the link to the current PCell (or MN) if the executed conditional reconfiguration command is for PSCell addition/change. Some information or guideline (e.g., by implicit manner) for the UE to determine what to do when a conditional reconfiguration command is executed may be required. In addition, the principles for applying CHO (or conditional configuration) to PCell change and the principles for applying CHO (or conditional configuration) to PSCell addition/change may be different due to different purposes. The UE behavior for different types of CHO (or conditional configuration) may need to be identified. Furthermore, some modifications for the PSCell addition procedure, the PSCell change procedure, the SN addition procedure, or the SN change procedure in MR-DC mode may be required when the CHO procedure (or the conditional reconfiguration procedure) is involved.

Implementations related to conditional PSCell addition (CPA) procedures and conditional PSCell change (CPC) procedures for different cases are described in the standards. Exemplary implementations of the CPC procedures will be provided as background information and aspects related to the present disclosure.

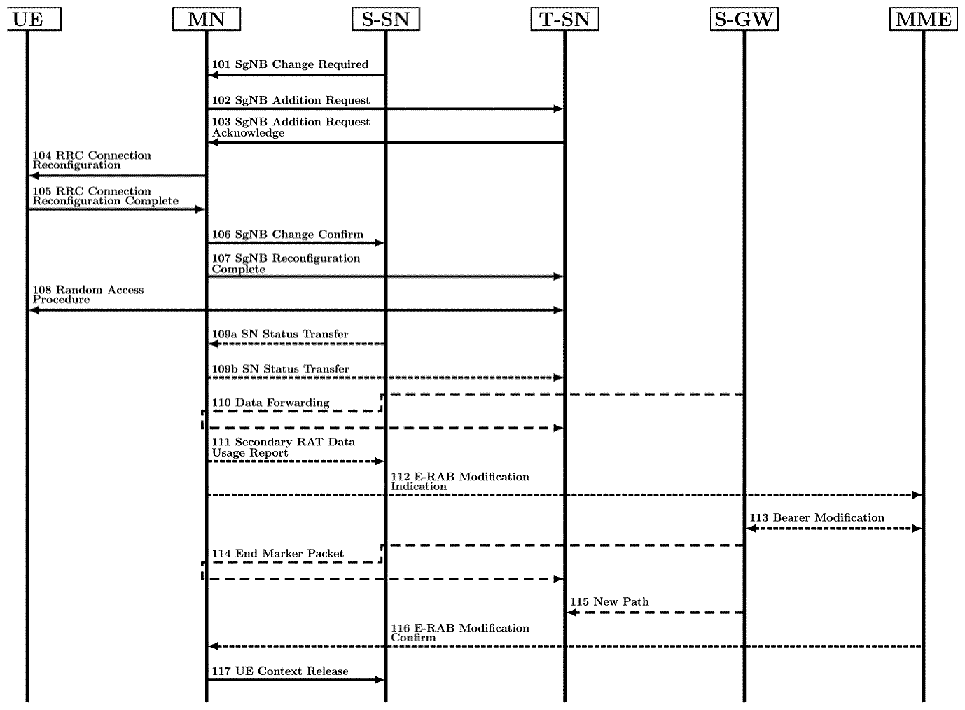

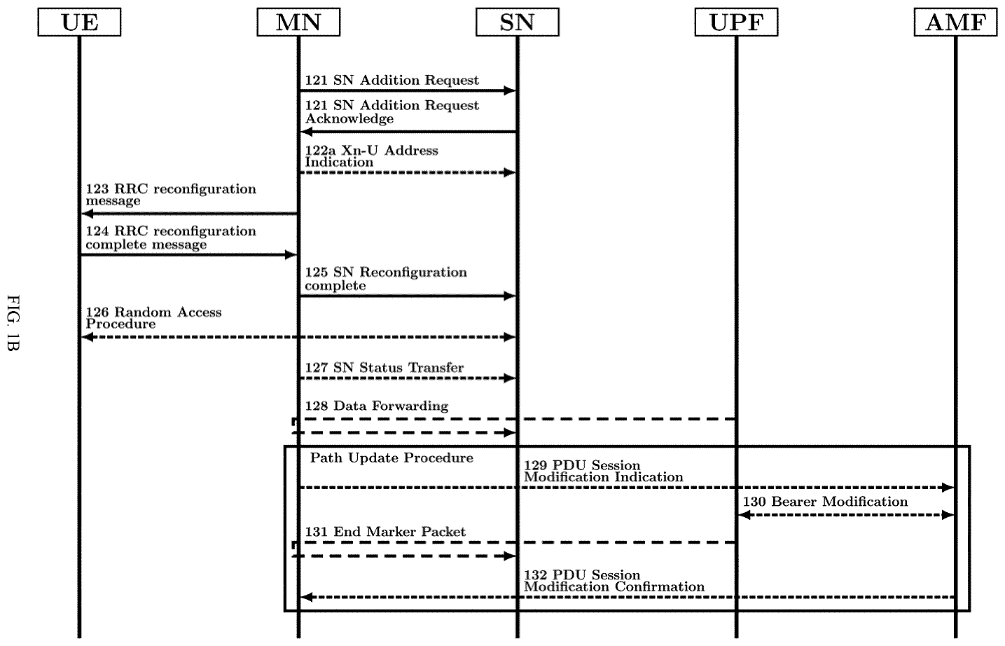

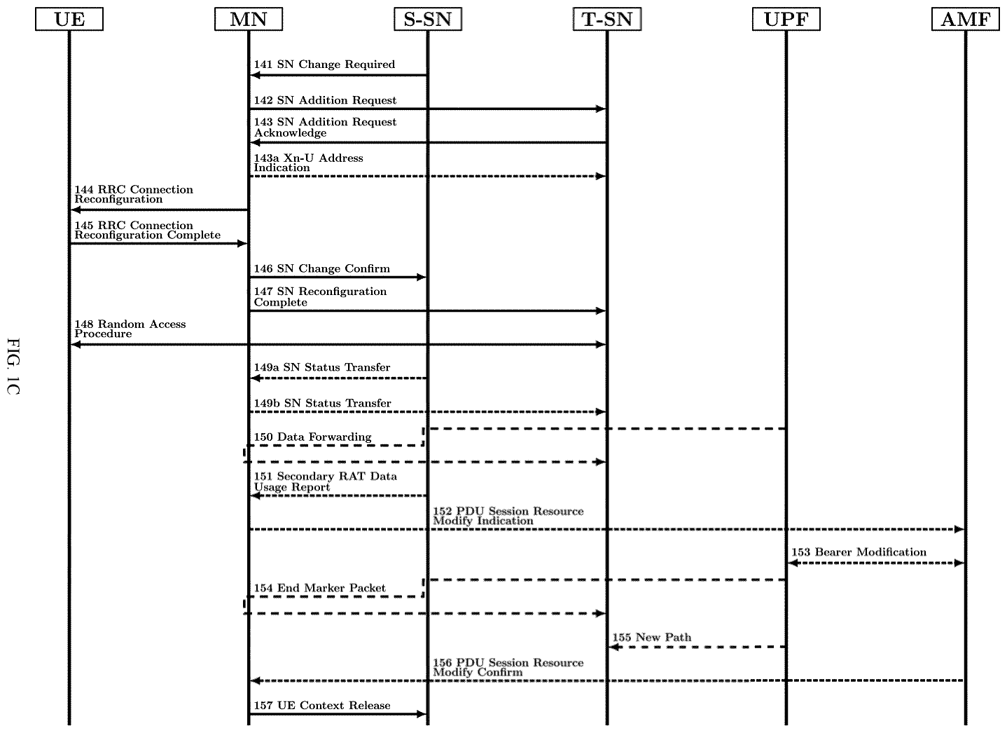

Referring to FIG. 1A, an example signaling flow for the SN-initiated Secondary Node Change for the EN-DC case as specified in 3GPP TS 37.340 V16.7.0, which is incorporated herein by reference, will be described.

The Secondary Node Change procedure as shown in FIG. 1A is initiated either by MN or SN and used to transfer a UE context from a source SN (S-SN) to a target SN (T-SN) and to change the SCG configuration in UE from one SN to another. The Secondary Node Change procedure always involves signaling over MCG SRB towards the UE.

In operation 101, the S-SN initiates the SN change procedure by sending Secondary gNB (SgNB) Change Required message which contains T-SN ID information and may include the SCG configuration (to support delta configuration) and measurement results related to the T-SN. For example, the S-SN sends the SgNB) Change Required message to the MN. In operations 102 and 103, the MN requests the T-SN to allocate resources for the UE by means of the SgNB Addition procedure, including the measurement results related to the T-SN received from the S-SN. For example, the MN sends SgNB Addition Request message to the T-SN and received, from the T-SN, SgNB Addition Request Acknowledge message. If forwarding is needed, the T-SN provides forwarding addresses to the MN. The T-SN includes the indication of the full or delta RRC configuration. In case the T-SN includes the indication of the full RRC configuration, the MN performs release of the SN terminated radio bearer configuration and release and add of the NR SCG configuration part towards the UE. In operations 104 and 105, the MN triggers the UE to apply the new configuration. For example, the MN indicates the new configuration to the UE in the RRC Connection Reconfiguration message including the NR RRC configuration message generated by the T-SN. The UE applies the new configuration and sends the RRC Connection Reconfiguration Complete message, including the encoded NR RRC response message for the T-SN, if needed. In case the UE is unable to comply with (part of) the configuration included in the RRC Connection Reconfiguration message, the UE performs the reconfiguration failure procedure (not shown). In operation 106, if the allocation of T-SN resources was successful, the MN confirms the release of the S-SN resources. If data forwarding is needed, the MN provides data forwarding addresses to the S-SN. If direct data forwarding is used for SN terminated bearers, the MN provides data forwarding addresses as received from the T-SN to S-SN. For example, the MN sends SgNB Change Confirm message to the S-SN. The reception of the SgNB Change Confirm message triggers the S-SN to stop providing user data to the UE and, if applicable, to start data forwarding. In operation 107, if the RRC connection reconfiguration procedure was successful, the MN informs the T-SN by sending SgNB Reconfiguration Complete message with the encoded NR RRC response message for the T-SN, if received from the UE. In operation 108, the UE synchronizes to the T-SN by performing Random Access procedure. For SN terminated bearers using RLC AM, the S-SN sends the SN Status Transfer to the MN, in operation 109a. The MN sends the SN Status Transfer to the T-SN, if needed, in operation 109b. In operation 110, data forwarding from the S-SN takes place, if applicable. The data forwarding may be initiated as early as the S-SN receives the SgNB Change Confirm message from the MN. In operation 111, the S-SN sends the Secondary RAT Data Usage Report message to the MN and includes the data volumes delivered to and received from the UE over the NR radio for the related E-RABs. The S-SN may send the Secondary RAT Data Usage Report message and perform data forwarding with MN/T-SN (operations 110 and 111) in any possible order. For example, the SgNB may send the report when the transmission of the related bearer is stopped. In operations 112 to 116, a path update is triggered by the MN, if applicable. Finally, in operation 117, the S-SN releases radio and C-plane related resources associated to the UE context upon reception of the UE Context Release message from the MN. Ongoing data forwarding may continue.

Referring to FIG. 1B, an example signaling flow for the MN-initiated Secondary Node Addition for the MR-DC with 5GC case as specified in 3GPP TS 37.340 V16.7.0 will be described.

The Secondary Node Addition procedure as shown in FIG. 1B is initiated by the MN and is used to establish an UE context at the SN in order to provide resources from the SN to the UE. For bearers requiring SCG radio resources, this procedure is used to add at least the initial SCG serving cell of the SCG. This procedure can also be used to configure an SN terminated MCG bearer (where no SCG configuration is needed).

The procedure starts at operation 121 with the MN deciding to request the T-SN to allocate resources for one or more specific PDU Sessions/QoS Flows, indicating QoS Flows characteristics (QOS Flow Level QoS parameters, PDU session level TNL address information, and PDU session level Network Slice info). For example, the MN sends SN Addition Request message to the SN. In addition, for bearers requiring SCG radio resources, the MN indicates the requested SCG configuration, including the entire UE capabilities and the UE capability coordination result. In this case, the MN also provides the latest measurement results for SN to choose and configure the SCG cells (one SCG cell or a plurality of SCG cells). The MN may request the SN to allocate radio resources for split SRB operation. In NGEN-DC and NR-DC, the MN always provides all the needed security information to the SN (even if no SN terminated bearers are setup) to enable SRB3 to be setup based on SN decision. For MN terminated bearer options that require Xn-U resources between the MN and the SN, the MN provides Xn-U UL TNL address information. For SN terminated bearers, the MN provides a list of available DRB IDs. The S-NG-RAN node may store this information and use the same when establishing SN terminated bearers. The SN may reject the request. For SN terminated bearer options that require Xn-U resources between the MN and the SN, the MN provides in operation 121 a list of QoS flows per PDU Sessions for which SCG resources are requested to be setup upon which the SN decides how to map QoS flows to DRB. In operation 122, if the RRM entity in the SN is able to admit the resource request, the RRM entity allocates respective radio resources and, dependent on the bearer type options, respective transport network resources. For bearers requiring SCG radio resources the SN triggers UE Random Access so that synchronization of the SN radio resource configuration can be performed. The SN decides for the PSCell and other SCG SCells and provides the new SCG radio resource configuration to the MN within an SN RRC configuration message contained in the SN Addition Request Acknowledge message. In case of bearer options that require Xn-U resources between the MN and the SN, the SN provides Xn-U TNL address information for the respective DRB, Xn-U UL TNL address information for SN terminated bearers, Xn-U DL TNL address information for MN terminated bearers. For SN terminated bearers, the SN provides the NG-U DL TNL address information for the respective PDU Session and security algorithm. If SCG radio resources have been requested, the SCG radio resource configuration is provided. In operation 122a, the MN provides Xn-U DL TNL address information in the Xn-U Address Indication message for SN terminated bearers using MCG resources. In operation 123, The MN sends the MN RRC reconfiguration message to the UE including the SN RRC configuration message, without modification. In operation 124, the UE applies the new configuration and replies to MN with MN RRC reconfiguration complete message, including an SN RRC response message for SN, if needed. In case the UE is unable to comply with (part of) the configuration included in the MN RRC reconfiguration message, the UE performs the reconfiguration failure procedure. In operation 125, the MN informs the SN that the UE has completed the reconfiguration procedure successfully via SN Reconfiguration Complete message, including the SN RRC response message, if received from the UE. In operation 126, if configured with bearers requiring SCG radio resources, the UE performs synchronization towards the PSCell configured by the SN. The UE may send the MN RRC reconfiguration complete message and perform the Random Access procedure towards the SCG in any suitable order. The successful RA procedure towards the SCG is not required for a successful completion of the RRC Connection Reconfiguration procedure. In operation 127, if PDCP termination point is changed to the SN for bearers using RLC AM, and when RRC full configuration is not used, the MN sends the SN Status Transfer to the SN. For SN terminated bearers or QoS flows moved from the MN, dependent on the characteristics of the respective bearer or QoS flow, the MN may take actions to minimize service interruption due to activation of MR-DC (Data forwarding) in operation 128. Finally, in operations 129 to 132, the update of the UP path towards the 5GC is performed via a PDU Session Path Update procedure, if applicable.

Referring to FIG. 1C, an example signaling flow for the SN-initiated Secondary Node Change for the MR-DC with 5GC case as specified in 3GPP TS 37.340 V16.7.0 will be described.

The Secondary Node Change procedure as shown in FIG. 1C is initiated by SN and used to transfer an UE context from a S-SN to a T-SN and to change the SCG configuration in UE from one SN to another. The Secondary Node Change procedure always involves signaling over MCG SRB towards the UE.

The Secondary Node Change procedure starts at operation 141 with the S-SN initiating the SN change procedure by sending the SN Change Required message to the MN, which contains a candidate target node ID and may include the SCG configuration (to support delta configuration) and measurement results related to the T-SN. In operations 142 and 143, the MN requests the T-SN to allocate resources for the UE by means of the SN Addition procedure, including the measurement results related to the T-SN received from the S-SN. For example, the MN sends the SN Addition Request message to the T-SN and receives the SN Addition Request Acknowledge message from the T-SN. If data forwarding is needed, the T-SN provides data forwarding addresses to the MN. The T-SN includes the indication of the full or delta RRC configuration. In operation, 143a, the MN provides Xn-U DL TNL address information in the Xn-U Address Indication message for SN terminated bearers using MCG resources. In operations 144 and 145, the MN triggers the UE to apply the new configuration. The MN indicates the new configuration to the UE in the MN RRC reconfiguration message including the SN RRC reconfiguration message generated by the T-SN, in operation 144. The UE applies the new configuration and sends the MN RRC reconfiguration complete message, including the SN RRC response message for the T-SN, if needed, in operation 145. In case the UE is unable to comply with (part of) the configuration included in the MN RRC reconfiguration message, the UE performs the reconfiguration failure procedure. In operation 146, if the allocation of T-SN resources was successful, the MN confirms the change of the S-SN. For example, the MN sends SN Change Confirm message to the S-SN. If data forwarding is needed, the MN provides data forwarding addresses to the S-SN. If direct data forwarding is used for SN terminated bearers, the MN provides data forwarding addresses as received from the T-SN to S-SN. The reception of the SN Change Confirm message triggers the S-SN to stop providing user data to the UE and, if applicable, to start data forwarding. In operation 147, if the RRC connection reconfiguration procedure was successful, the MN informs the T-SN via SN Reconfiguration Complete message with the included SN RRC response message for the T-SN, if received from the UE. In operation 148, the UE synchronizes to the T-SN. For example, the UE performs the Random Access procedure with the T-SN. In operation 149, if PDCP termination point is changed for bearers using RLC AM, the S-SN sends the SN Status Transfer message to the MN (operation 149a), which the MN sends then to the T-SN (operation 149b), if needed. In operation 150, data forwarding from the S-SN takes place, if applicable. The data forwarding may be initiated as early as the S-SN receives the SN Change Confirm message from the MN. In operation 151, the S-SN sends the Secondary RAT Data Usage Report message to the MN and includes the data volumes delivered to and received from the UE. The SN may send the Secondary RAT Data Usage Report message and perform data forwarding with MN/T-SN in any suitable order. The SN may send the report when the transmission of the related QoS flow is stopped. In operations 152 to 156, a PDU Session path update procedure is triggered by the MN, if applicable. The Secondary Node Change procedure ends at operation 157 with the S-SN releasing radio and C-plane related resources associated to the UE context upon reception of the UE Context Release message. Ongoing data forwarding may continue.

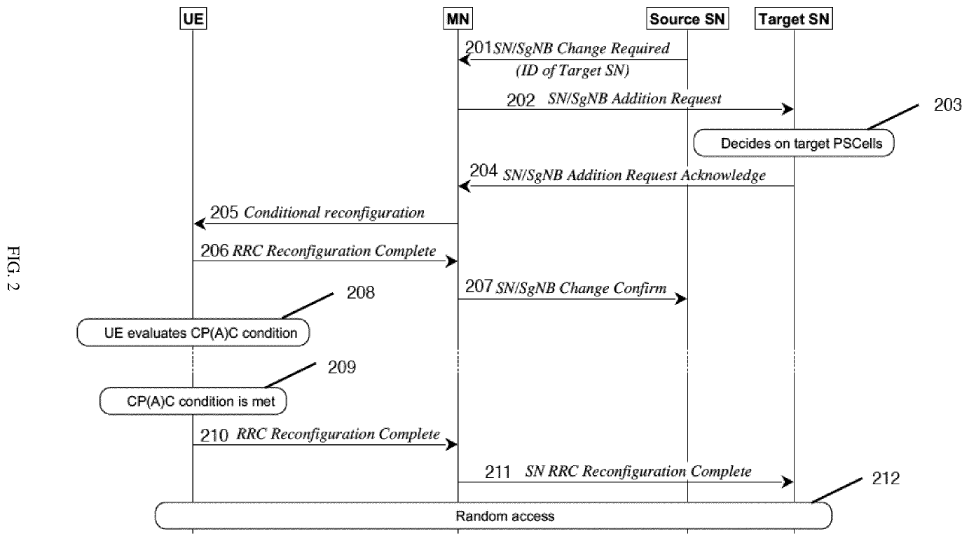

Now referring to FIG. 2, another implementation for (conditional) PSCell change within a different SN (i.e., inter-SN) as specified in MR-DC WI Release 17 will be described. FIG. 2 illustrates a simplified example signaling flow for SN-initiated CPC.

As already described hereinbefore, (conditional) PSCell change may be initiated by the MN (MN-initiated PSCell change or MN-initiated conditional PSCell change) or the S-SN (SN-initiated PSCell change or conditional SN-initiated PSCell change). In either case, a common operation of SN Addition towards the T-SN is present.

As shown in FIG. 2, the Source SN (S-SN) indicates to the Master Node (MN) the ID of the Target SN (T-SN) that shall be contacted for preparing one or more target PSCells, in operation 201. The S-SN sends an SN/SgNB Change Required message to the MN. The SN/SgNB Change Required message may include SGC configuration for PSCells to be prepared by T-SNs. For example, the S-SN may suggest a list of one or more PSCells to be prepared by each T-SN. The S-SN may also provide a CPC execution condition for each suggested target PSCell. The list of the one or more PSCells to be prepared by each T-SN and if provided, the CPC execution condition for each suggested target PSCell may be included in the SN/SgNB Change Required message. The SN/SgNB Change Required message may further include an indication of the ID of the T-SN that shall be contacted. In addition, the S-SN may provide measurements to the MN, which may include PSCells that are no target candidate PSCells to be prepared by the T-SN. The change required message may further include a CPC indication indicating that the PSCell change procedure is the conditional PSCell change (CPC) procedure.

In response to receiving the SN/SgNB Change Request message from the S-SN, the MN sends a first message (also referred to as an addition request message) to the T-SN indicated by the S-SN, in operation 202. The addition request message may be an SN/SgNB Addition Request message. The MN may identify the T-SN using the ID received from the S-SN and send the SN/SgNB Addition Request message to the T-SN. The addition request message may include the SGC configuration (e.g., the list of one or more PSCells to be prepared by the T-SN) received from the S-SN. The addition request message may further include the CPC indication received from the S-SN.

In operation 203, the T-SN decides on one or more candidate target PSCells to prepare. For example, the T-SN may be informed about the list of the one or more PSCells by the MN via SN/SgNB Addition Request message (e.g., the SGC configuration). The T-SN may decide for each PSCell in the list of the one or more PSCell whether the PSCell can be prepared by the T-SN. If the PSCell can be prepared, the PSCell is acknowledged by the T-SN and the T-SN prepares for the PSCell. Otherwise, the T-SN rejects the PSCell. The T-SN can thus either accept all target PSCells in the list of the one or more PSCells or a subset thereof. T-SN is not allowed to come up with new PSCells (i.e., not indicated by the S-SN via the MN in case of SN-initiated CPC).

In operation 204, the T-SN sends to the MN the configuration (e.g., CG configuration) for each PSCell acknowledged and prepared by the T-SN. For example, the T-SN may send an SN/SgNB Addition Request Acknowledge message including the configuration for each prepared/acknowledged target PSCell. In the SN/SgNB Addition Request Acknowledge message, the T-SN may further signal the ID of each target prepared/acknowledged PSCell. In response to receiving the configuration for each PSCell prepared by the T-SN, the MN may inform the S-SN about the configuration for each PSCell prepared by and received from the T-SN. That is, the S-SN may be informed about which candidate PSCells were accepted or rejected by the T-SN. The S-SN may also update the (measurement) configuration with respect to the candidate PSCells which were accepted or rejected by the T-SN. In one implementation, the S-SN may update during or after the PSCell change preparation/configuration of the UE.

In operation 205, the MN sends to the UE a (re-)configuration (e.g., a conditional reconfiguration) message including the configuration of one or more PSCells (i.e., the one or more candidate target PSCells acknowledged and prepared by the T-SN and/or in case of an update by the S-SN, the updated configuration for one or more PSCells). The reconfiguration message may also include the CPC execution conditions for each of the PSCells. For example, the MN may send a Conditional (re-)configuration message to the UE.

In operation 206, the UE sends a message to the MN confirming reception of the (re-)configuration message and, in operation 207, the MN confirms to the S-SN the SN change preparation. For example, the UE may send a RRC Reconfiguration Complete message to the MN. The RRC Reconfiguration Complete message may include an SN/SgNB Change Confirm message to be sent by the MN to the S-SN.

In operation 208, the UE evaluates the CPC execution conditions of the one or more PSCells. During evaluation, the UE may determine, in operation 209, that the CPC execution condition for a particular PSCell in the T-SN among the one or more PSCells is met.

In operation 210, in response to determining that the CPC execution condition is met for the particular PSCell, the UE sends a message to the MN indicating execution of the PSCell change configuration. For example, the UE may send a RRC Reconfiguration Complete message to the MN. The RRC Reconfiguration Complete message may have embedded an SN RRC Reconfiguration Complete to the T-SN, which prepared the particular PSCell, the CPC execution condition of which determined to the met.

In operation 211, the MN sends SN RRC Reconfiguration Complete embedded in the RRC Reconfiguration Complete message received from the UE to the T-SN.

In operation 212, the UE completes the Random Access procedure.

The signaling flow for the (conditional) PSCell change procedure is described for the SN-initiated case with reference to FIG. 2. The (conditional) PSCell change procedure shown in FIG. 2 is initiated by the S-SN. The signaling flow for the (conditional) PSCell change procedure for the MN-initiated case (i.e., the (conditional) PSCell change procedure is initiated by the MN) is similar to FIG. 2, except that the operation 201 is not performed. The (conditional) PSCell change procedure is instead initiated by the MN. The T-SN and PSCell change execution conditions (e.g., CPC execution conditions in case of the conditional PSCell change procedure) are decided in this case by the MN. Also, the signaling flow for PSCell Addition (e.g., Conditional PSCell Addition (CPA) in case of the conditional PSCell change procedure) is similar to FIG. 2, except that UE has only MN (without S-SN). In this case, the operations 201 and 210 are not performed.

As described above with reference to FIG. 2, in response to receiving the SN/SgNB Addition Request Acknowledged message from the T-SN in operation 204, including the configuration for each PSCell acknowledged by the T-SN (e.g., the CG configuration), the MN may inform the S-SN which PSCells have been accepted and/or which PSCells have been rejected by T-SN. The S-SN may respond with a new configuration (e.g., if there is redundancy in the configuration provided in SN/SgNB Change Required message, in operation 201 of FIG. 2). For example, some measurement gaps may not be needed anymore as certain PSCells have not been acknowledged by the T-SN. Additionally, the CPC execution conditions associated with rejected PSCells may be removed from the configuration, avoiding that the UE evaluates the CPC execution for PSCells rejected by the T-SN. The MN may obtain the new configuration (i.e., an updated configuration) from the S-SN before sending the (Conditional) reconfiguration message to the UE.

The change in the SGC configuration provided by the S-SN may cause a mismatch, especially when the T-SN uses the SGC configuration (including measurement configuration) as a reference during preparation of the GC configuration for each candidate target PSCell. As described above, the GC configurations for the candidate target PSCells provided by the T-SN is taken into use when the UE selects a particular candidate PSCell and attempts accessing the particular candidate PSCell (i.e., once the CPC execution condition of the particular candidate PSCell is met). If the CG configuration for each candidate target PSCell is provided in delta manner (e.g., with reference to the SGC configuration used in the source PSCell/S-SN), the mismatch may occur, if the S-SN performs updates for the measurement configuration (e.g., the measurement gap configuration) after operation 204 shown in FIG. 2. To avoid the mismatch, the S-SN may need to inform once again the T-SN (via the MN) about the updated configuration, allowing the T-SN to modify the GC configuration for the candidate target PSCell accordingly. This requires additional inter-node signaling (e.g., additional signaling from the S-SN to the T-SN via the MN, and from the T-SN to the MN, etc.) and is time-consuming.

Implementations of the present disclosure provide for a coordination between the S-SN and the T-SN with which time-consuming additional inter-node signaling can be avoided. In particular, the S-SN and the T-SN coordinate whether full or delta configuration is to be used at least for parts such as the measurement configuration or the measurement IDs of the configuration for candidate target PSCells provided by the T-SN.

Now, the methods for a Conditional Primary Secondary Cell Group (SCG) Cell (PSCell) change (CPC) procedure according to some example implementations of the present disclosure will be described. It should be understood that the methods described are not limited for use with the CPC procedure and can also be used for a (non-conditional/normal) Primary Secondary Cell Group (SCG) Cell (PSCell) change procedure.

The principle underlying the example implementations of the present disclosure is that the T-SN is provided with configuration information based on which the T-SN determines whether to provide full configuration or delta configuration of CG configuration for each candidate target PSCell acknowledged by the T-SN, or of at least one or more parts of thereof. The configuration information (or configuration-related information) is to be understood as information relating to a type of the configuration, i.e., whether the configuration is a full configuration or a delta configuration. The configuration information may be an indication that the CPC procedure was initiated by the S-SN, based on which the T-SN determines to provide the full configuration. In another example, the configuration information indicates to (or configures) the T-SN to use the full configuration. In another example, the configuration information indicates to the T-SN at least one parameter, based on which the T-SN determines to use the full configuration for the at least one parameter. In yet another example, the configuration information is a request to provide configuration for one or more candidate target PSCells to be acknowledged by the T-SN, the request determining for at least a first parameter of the configuration mandatory use of the full configuration or optional use of the delta configuration, and for at least a second parameter optional use of the full or delta configuration, based on which request the T-SN determines whether to use the full or delta confirmation. The configuration information (e.g., the indication) may be implicit, wherein the T-SN derives based on the presence of any information or information element in a message that the full configuration is to be provided. The configuration information (e.g., the indication) may also be explicit, indicating to use full configuration or identifying a parameter to be provided in full configuration, or may be a control command configuring the T-SN to provide full configuration (e.g., for a parameter identified by the control command). The T-SN is thus required to provide the full configuration for at least one or more parts of the CG configuration (e.g., information related to measurement) for each candidate target PSCell. The T-SN may determine whether to provide the full configuration or the delta configuration for remaining parts of the CG configuration (e.g., information not related to measurement).

Some more details regarding full and delta configuration will be described hereinbelow.

For a parameter of a full configuration an absolute value is determined and provided, while for the same parameter also a difference to a previous value can be determined and provided (i.e., delta configuration). The previous value is known when determining the delta configuration, as described e.g. in section 11.2.2 of 3GPP TS 38.331 V16.5.0, which is incorporated herein by reference.

CG-Config (CG configuration) is a message used to transfer the SCG radio configuration as generated by the SgNB or SeNB. This message can also be used by a CU to request a DU to perform certain actions, such as to request the DU to perform a new lower layer configuration. The message is sent from the Secondary gNB or eNB to master gNB or eNB, alternatively from CU to DU. The CG-Config message includes, among others, scg-CellGroupConfig (i.e., an information element or parameters). The scg-CellGroupConfig contains the RRCReconfiguration message (containing only secondaryCellGroup and/or measConfig and/or otherConfig and/or conditionalReconfiguration and/or bap-Config and/or iab-IP-AddressConfigurationList) to be sent to the UE, used upon SCG establishment or modification, as generated by the (target) SgNB, or including the current SCG configuration of the UE, when provided in response to a query from MN, or in SN triggered SN change in order to enable delta signaling by the target SN.

In section 11.2.3 of 3GPP TS 38.331 V16.5.0, which is incorporated herein by reference, mandatory information in inter-node RRC messages are described. Based on the received AS configuration, the target node can indicate the delta (difference) to the current AS configuration (as included in HandoverCommand) to the UE. The fields newUE-Identity and t304 included in ReconfigurationWithSync are not used for delta configuration purpose.

For fields in CG-Config and CG-ConfigInfo, absence of the field means that the receiver maintains the values informed via the previous message. Every time there is a change in the configuration covered by a listed field, the MN or SN shall include the field and the MN or SN shall provide the full configuration provided by that field unless stated otherwise. Otherwise, if there is no change, the field can be omitted: configRestrictInfo; gapPurpose; measGapConfig (for which delta signaling applies); measGapConfigFR2 (for which delta signaling applies); measResultCellListSFTD; measResultSFTD-EUTRA; sftdFrequencyList-EUTRA; sftdFrequencyList-NR; uc-CapabilityInfo; servFrequenciesMN-NR.

For other fields in CG-Config and CG-ConfigInfo, the sender shall always signal the appropriate value even if same as indicated in the previous inter-node message, unless explicitly stated otherwise.

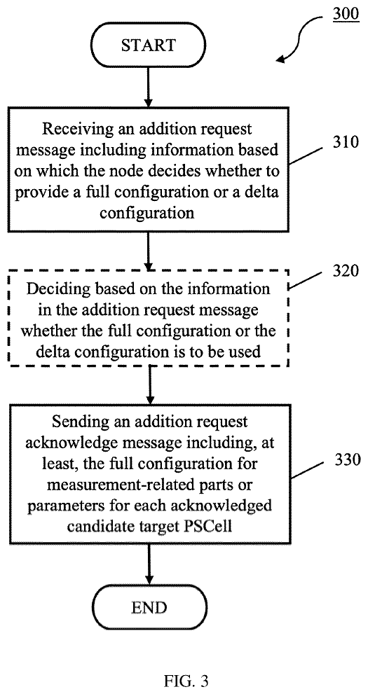

FIG. 3 illustrates a flow chart of a method for a conditional Primary Secondary Cell Group (SCG) Cell (PSCell) change (CPC) procedure according to an example implementation of the present disclosure. The method may be performed in a node of a wireless communication network. For example, the method may be performed in a target secondary node (T-SN).

The method begins at block 310. As part of the CPC procedure, the T-SN receives a first message (referred to as an addition request message hereinforth) in block 310. The addition request message may be sent from a master node (MN). An example of the addition request message received by the T-SN is the SN/SgNB Addition Request message as described above. The addition request message includes configuration information based on which the T-SN determines whether to provide a full configuration or a delta configuration.

The addition request message may further include an SCG configuration (e.g., radio resources, a list of one or more PSCells to be prepared by the T-SN). Optionally, the addition request message may further include an CPC indication to indicate CPC procedure.

In some implementations, the configuration information is an indication (e.g., a flag or bit) indicating whether the CPC procedure was initiated by a source secondary node (S-SN) or the MN. For example, a value of “1” of the bit may indicate that the CPC procedure was initiated by the S-SN, while a value of “0” indicate that the CPC procedure is MN-initiated (or vice versa). In other examples, the presence of the configuration information (i.e., the indication) indicates the SN-initiated CPC procedure.

In other implementations, the configuration information is configuration information (e.g., a flag or one or more bits) indicating use of the full configuration or the delta configuration. For example, a value of “1” of the bit may indicate use of the full configuration, while a value of “0” indicate use of the delta configuration (or vice versa). In other examples, the presence of the configuration information indicates use of the full configuration.

The configuration information may be included by the MN in the addition request message and set based on whether the CPC procedure was initiated by the S-SN (e.g., in response to the MN receiving a change required message from the S-SN) or the MN. The MN may also set the configuration information in accordance with configuration information the MN receives from the S-SN (e.g., in the change request message). The configuration information the MN receives from the S-SN indicates whether the S-SN expects to receive the full configuration or the delta configuration. That is, the T-SN is to provide the full configuration or the delta configuration in accordance with the configuration information provided by the S-SN.

In block 320, the T-SN determines based on the configuration information in the addition request message whether the full configuration or the delta configuration is to be used. If the configuration information indicates use of the full configuration, the T-SN determines to use the full configuration for candidate target PSCells acknowledged by the T-SN. For example, if the indication is that the CPC procedure is SN-initiated, the T-SN determines to provide the full configuration. The T-SN uses the full configuration at least for measurement-related parts (also referred to as measurement-related information) of the configuration (i.e., the CG configuration). Examples of the measurement-related parts include measurement configuration related parameters such as the measurement gap or measurement ID. The T-SN may use the full configuration for all measurement-related parts of the configuration or at least part thereof, particularly measurement-related parameters not being void or default but those being set by the T-SN. Examples of measurement-related parameters to be included in the full configuration comprise measurement gaps or measurement IDs.

In block 320, the T-SN may also determine based on the configuration information in the addition request message which measurement-related parts of the configuration, if not all, are to be provided in the full configuration. In some implementations, the addition request message may include configuration information indicating measurement-related parts or parameters of the configuration to be provided in full configuration. The configuration information may be defined by the MN or provided by the S-SN in the change required message.

For the measurement-related parts or parameters not determined in block 320 to be provided in the full configuration, the T-SN may decide whether to provide these parts or parameters in full or delta configuration. For example, if all measurement-related parts are to be provided in the full configuration, the T-SN decides whether to use the full or delta configuration for non-measurement related parts (also referred to as the remainder herein).

The operation of the T-SN in block 320 is optional and the T-SN may use the full configuration if the configuration information in the addition request message indicates that the full configuration is to be used. For example, if the addition request message includes the indication that the CPC procedure was initiated by the S-SN, the T-SN uses the full configuration for the measurement-related parts or parameters for the candidate target PSCells. Similar, if the addition request message includes the configuration information that the full configuration is to be used, the T-SN uses the full configuration for the measurement-related parts or parameters for the candidate target PSCells. The remainder of the configuration for the candidate target PSCells are provided in delta configuration or if the T-SN decides, in full configuration.

The T-SN further decides on candidate target PSCells to be acknowledged and prepared (not shown in FIG. 3). For example, the T-SN may decide which of the PSCells among the list of one or more PSCells received with the addition request message to acknowledge. For acknowledged PSCells, the T-SN may generate the configuration to be provided to the MN. The T-SN generates the full configuration of measurement-related parts or parameters for the acknowledged PSCells (e.g., measurement gap configuration or measurement IDs) and may generate full or delta configuration of the remainder. For example, the T-SN generates measurement configuration related Information Elements (IEs) for each acknowledged candidate target PSCells.

In block 330, the T-SN sends a second message (referred to as an addition request acknowledge message hereinforth) including, at least, the full configuration for the acknowledged candidate target PSCells. For example, as described above, the addition request acknowledge message includes the measurement-related parts or parameters (e.g., the measurement configuration related IEs) for each acknowledged candidate target PSCells. An example of the addition request acknowledge message sent by the T-SN is the SN/SgNB Addition Request Acknowledge message as described above. The addition request message may be sent to the MN. Together with the measurement-related parts or parameters in full configuration, the addition request acknowledge message may also include the non-measurement related parts or parameters in full or delta configuration.

The addition request acknowledge message (i.e., the SN/SgNB Addition Request Acknowledge message) may include the following information (IEs):

| CG-Config-IEs ::= | SEQUENCE { | |
|---|---|---|
| scg-CellGroupConfig | OCTET STRING (CONTAINING RRCReconfiguration) | OPTIONAL, |
| scg-RB-Config | OCTET STRING (CONTAINING RadioBearerConfig) | OPTIONAL, |
| configRestrictModReq | ConfigRestrictModReqSCG | OPTIONAL, |
| drx-InfoSCG | DRX-Info | OPTIONAL, |
| candidateCellInfoListSN | OCTET STRING (CONTAINING MeasResultList2NR) | OPTIONAL, |
| measConfigSN | MeasConfiqSN | OPTIONAL, |
| selectedBandCombinationNR | BandCombinationInfoSN | |
| fr-InfoListSCG | FR-InfoList | OPTIONAL, |
| candidateServingFreqListNR | CandidateServingFreqListNR | OPTIONAL, |
| nonCriticalExtension | CG-Config-v1540-IEs | OPTIONAL |

}

The “measConfigSN” IE may include the following information (IEs):

| | |
|---|---|
| MeasConfig ::= | SEQUENCE { |

-- Measurement objects

| | | |
|---|---|---|
| measObjectToRemoveList | MeasObjectToRemoveList | OPTIONAL, -- Need ON |
| measObjectToAddModList | MeasObjectToAddModList | OPTIONAL, -- Need ON |

-- Reporting configurations

| | | |
|---|---|---|
| reportConfigToRemoveList | ReportConfigToRemoveList | OPTIONAL, -- Need ON |
| reportConfigToAddModList | ReportConfigToAddModList | OPTIONAL, -- Need ON |

-- Measurement identities

| | | |
|---|---|---|
| measIdToRemoveList | MeasIdToRemoveList | OPTIONAL, -- Need ON |
| measIdToAddModList | MeasIdToAddModList | OPTIONAL, -- Need ON |

-- Other parameters

| | | |
|---|---|---|
| quantityConfig | QuantityConfig | OPTIONAL, -- Need ON |
| measGapConfig | MeasGapConfig | OPTIONAL, -- Need ON |
| s-Measure | RSRP-Range | OPTIONAL, -- Need ON |
| preRegistrationInfoHRPD | PreRegistrationInfoHRPD | OPTIONAL, -- Need OP |

| | |
|---|---|
| speedStatePars | CHOICE { |
| release | NULL, |
| setup | SEQUENCE { |
| mobilityStateParameters | MobilityStateParameters, |
| timeToTrigger-SF | SpeedStateScaleFactors |

```
      }
    }
  /* ---- clipped ---- */
}
```

In accordance with the implementations of the present disclosure, the “measConfigSN” in the CG-Config-IEs are in full configuration. The remainder (i.e., the remaining parts) are either in full or delta configuration depending on the decision of the T-SN.

In some examples of the implementations, one or more IEs inside the “measConfigSN” such as measurement gap config “MeasGapConfig” or IEs related to measurement ID such as “measIdToRemoveList” or “measIdToAddModist” are in full configuration, while other IEs such as “s-Measure” or “speedStatePars” can be in delta configuration. The configuration information in the addition request message may specify which IEs in “measConfigSN” are to be provided in the full configuration in case of SN-initiated CPC procedure. Other examples of measurement-related information are related to the following parameters in a measurement configuration of a CG configuration IE: CondReconfigToAddModList, MeasConfig, MeasGapConfig, MeasId, MeasIdleConfig, MeasIdToAddModList.

The method ends after block 330. It should be understood that the operations of the method shown in FIG. 2 form part of the (Conditional) Primary Secondary Cell Group (SCG) Cell (PSCell) change procedure in the cellular wireless communication networks. The operations of the method shown in FIG. 2 implement the principle underlying the example implementations of the present disclosure and allow coordination of the measurement configuration between nodes to avoid time-consuming additional inter-node signaling.

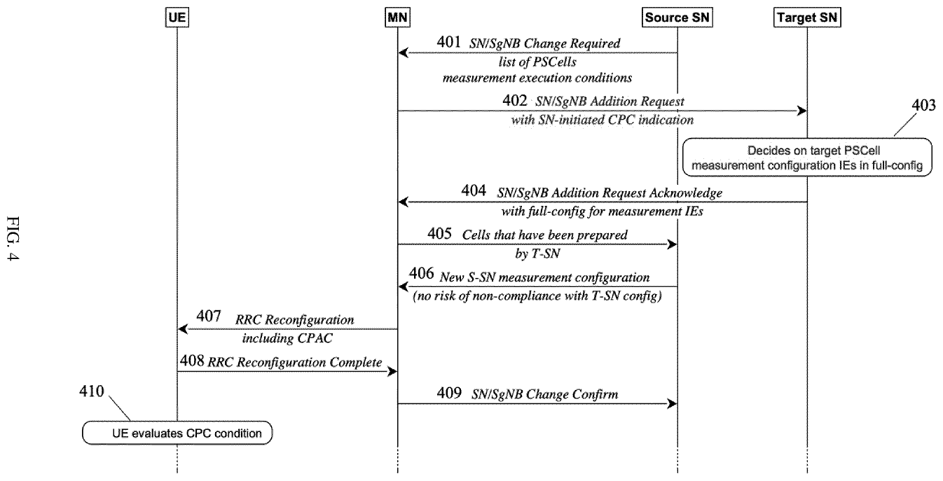

Referring to FIGS. 4 to 6, example implementations of the present disclosure in the Conditional Primary Secondary Cell Group (SCG) Cell (PSCell) change (CPC) procedure in the cellular wireless communication network will now be described. The cellular wireless communication network comprises a master node (MN), a source secondary node (Source SN or S-SN), a target secondary node (Target SN or T-SN) and an user equipment (UE).

FIG. 4 illustrates a simplified example signaling flow of a method for the Conditional Primary Secondary Cell Group (SCG) Cell (PSCell) change (CPC) procedure with SN-initiated indicator according to an example implementation of the present disclosure. The method of FIG. 4 implements the above-described principle and more specifically, concerns the example wherein the configuration information based on which the secondary node (such as the T-SN) determines whether to provide the full configuration or the delta configuration for measurement-related information for one or more candidate target PSCells acknowledged by the node comprises an indication that the PSCell change procedure is initiated by another secondary node (such as the S-SN). The CPC procedure is SN-initiated.

In operation 401, the MN receives a third message (also referred to as a change required message such as an SN/SgNB Change Required message) from the S-SN. The SN Change Required message includes a list of PSCells selected by the S-SN (e.g., based on measurement reports) and CPC execution conditions for all PSCells selected by the S-SN. The operation 401 corresponds to the operation 201 shown in FIG. 2. Further description is therefore omitted.

In operation 402, the MN requests the T-SN to perform the SN Addition procedure. For example, the MN sends a first message (also referred to as an addition request message such as an SN/SgNB Addition Request message) to the T-SN. The operation 402 is similar to the operation 202 shown in FIG. 2. In addition to what is described with reference to FIG. 2, the addition request message of operation 402 comprises an indicator indicating that the CPC procedure was initiated by the S-SN. The indicator is to inform the T-SN that the addition request message is sent as part of an SN-initiated CPC procedure. The indicator is to provide configuration information to the T-SN based on which the T-SN determines to provide full configuration for measurement-related information (e.g., parts, parameters or configuration elements related to measurements) for one or more candidate target PSCells acknowledged by the T-SN. The T-SN needs to use the full configuration for the measurement-related information. For example, the measurement-related information to be provided in the full configuration is related to a measurement configuration of a Cell Croup (CG) configuration-related Information Element (IE), particularly to at least one of the following parameters: CondReconfigToAddModList, MeasConfig, MeasGapConfig, MeasId, MeasIdleConfig, MeasIdToAddModList.

In operation 403, which is similar to operation 203 shown in FIG. 2, the T-SN decides on the target PSCells (i.e., whether to acknowledge or reject the target PSCells) and generates the configuration for acknowledged PSCells. Different from the description for operation 203, the T-SN generates the measurement-related information of the configuration in full configuration and the remainder in full or delta configuration. For example, the T-SN decides on the target PSCells using the PSCells included in the list of PSCells selected by the S-SN and sent to the T-SN with the addition request message.

In operation 404, the T-SN sends to the MN a second message (referred to as an addition request acknowledgement message such as SN/SgNB Addition Request Acknowledgement message) including configuration for each of the target PSCells acknowledged by the T-SN. The target PSCells may be all or a subset of the PSCells included in the list of PSCells selected by the S-SN. Thanks to the indicator, the configuration for each of the target PSCells includes the full configuration for the measurement-related information. The configuration may further include non-measurement related information (i.e., the remainder) in full or delta configuration. The non-measurement related information is related to at least one of the following parameters: scg-CellGroupConfig, scg-RB-Config, drx-InfoSCG, selectedBandCombinationNR, candidateServingFreqListNR. The operation 404 corresponds to the operation 204 shown in FIG. 2. Further description is therefore omitted.

In operation 405, the MN informs the S-SN on the list of PSCells acknowledged by the T-SN. For example, the MN sends the list of PSCells to the S-SN. The S-SN analyzes the list (not shown in FIG. 4) to determine whether the configuration (e.g., the SCG configuration of the S-SN) requires updating (e.g., measurement gap removal if inter-frequency PSCell candidates have not been acknowledged). The S-SN performs the update of the configuration (i.e., measurement reconfiguration). As the S-SN receives the full configuration for the acknowledged PSCells via the MN from the T-SN, a risk that the update of the configuration at the S-SN may result in configuration mismatch regarding the configuration prepared by the T-SN in operations 403 and 404 can be avoided. The S-SN provides an updated configuration (i.e., new S-SN measurement configuration) to the MN in operation 406.

In operation 407, the MN reconfigures the UE (e.g., by sending a fourth message such as an RRC Reconfiguration message including CPC execution conditions to the UE; the RRC Reconfiguration message may include Conditional PSCell Addition/Change (CPAC)) and, in operation 408, receives the confirmation from the UE (e.g., by receiving a fifth message such as an RRC Reconfiguration Complete message). The successful configuration of the UE for CPC is indicated to S-SN in operation 409. For example, the MN may send a sixth message (referred to as a change confirm message such as the SN/SgNB Change Confirm message) to the S-SN. The UE starts evaluating the CPC execution conditions in operation 410, for example directly after sending the RRC Reconfiguration Complete message in operation 408 or later. The operations 407 to 410 corresponds to the operations 205 to 209 shown in FIG. 2. Further description is therefore omitted.

In some implementations, the SN/SgNB Change Required message sent from the S-SN to the MN may include (at least): identification of one or more T-SNs (e.g., the PCI of each T-SN), SCG configuration (e.g., radio resources, a list of candidate PSCells selected by the S-SN, CPC execution conditions) and CPC indication (i.e., indication that the PSCell change procedure is a conditional PSCell change procedure). The SN/SgNB Addition Request message sent from the MN to the T-SNs (e.g., using the PCIs included in the SN/SgNB Change Required message) may include (at least): the SCG configuration (e.g., the SCG configuration included in the SN/SgNB Change Required message), the CPC indication (e.g., the CPC indication included in the SN/SgNB Change Required message) and the SN-initiated indicator (i.e., the configuration information that the SN initiated the CPC). The indicator may be a flag or a bit. The SN/SgNB Addition Request Acknowledge message prepared by the T-SN and sent from the T-SN to the MN may include (at least): CG configuration for the PSCell acknowledged by the T-SN with full configuration of measurement-related parameters (e.g., measurement gap or measurement ID) and full or delta configuration for non-measurement related parameters. The T-SN decides on the non-measurement related parameters to be provided in full or delta configuration. Furthermore, only a subset of the measurement-related parameters may be provided in full configuration. For example, measurement-related parameters being void or default may be provided in delta configuration. Also, in some implementations, the S-SN may provide configuration information via the MN to the T-SN indicating the measurement-related parameters to be provided in full configuration. The configuration information included in the messages is not limited to the examples described herein.

Still referring to the illustration of FIG. 4, the operations performed by nodes or functions of the cellular wireless communication network, that are involved in the method for the CPC procedure with SN-initiated indicator, will be described.

In an example, a function in the cellular wireless communication network or a node such as the MN sends the SN Addition Request message to the T-SN (operation 402 shown in FIG. 4). The SN Addition Request message includes configuration information based on which the T-SN determines whether to provide a full configuration or a delta configuration for measurement-related information for one or more candidate target PSCells acknowledged by the T-SN. The function or node receives the SN Addition Request Acknowledge from the T-SN (operation 404 shown in FIG. 4). The SN Addition Request Acknowledge includes the full configuration or the delta configuration for measurement-related information for the one or more candidate target PSCells acknowledged by the T-SN, as determined by the T-SN in accordance with the configuration information. The SN Addition Request Acknowledge message may further include full configuration or delta configuration for non-measurement related information for the one or more candidate target PSCells acknowledged by the T-SN.

As described above, the configuration information comprises an indication that the CPC procedure is initiated by the S-SN (i.e., SN-initiated indicator). The function or node receives the SN Addition Request Acknowledge message including the full configuration for the measurement-related information is received from the T-SN in response to sending the SN Addition Request message with the SN-initiated indicator.

The function or node may further receive the SN Change Required message from the S-SN (operation 401 shown in FIG. 4). The SN Change Required message includes a list of PSCells selected by the S-SN. The one or more candidate target PSCells included in the SN Addition Request Acknowledge are at least a subset of the list of PSCells. The list of PSCells may be send with the SN Addition Request message to the T-SN. The SN Change Required message may further include a PSCell change or CPC execution condition for PSCells in the list of PSCells.

The function or node may further generate the SN Addition Request message with the SN-initiated indicator in response to receiving the SN Change Required message from the S-SN. Said differently, the function or node may determine based on the reception of the SN Change Required message and/or configuration information included therein that the S-SN initiated the PSCell change or CPC procedure. The node or function may set the SN-initiated indicator accordingly.

The function or node may also determine that the MN initiated the PSCell change or CPC procedure. That is, the function or node does not receive the SN Change Required message from the S-SN. The node or function may set the SN-initiated indicator to MN-initiated. The indication therefore indicates whether the PSCell change or CPC procedure is initiated by the S-SN or the MN. The function or node may generate the SN Addition Request message with the indication that the PSCell change or CPC procedure is initiated by the MN. The SN Addition Request Acknowledge received from the T-SN then includes the full configuration for the measurement-related information. The function or node may generate the full configuration for the measurement-related information using the full configuration received from the T-SN.

The function or node may also send information on the one or more target PSCells acknowledged by the T-SN to the S-SN (operation 405 shown in FIG. 4) and receives an updated full configuration for measurement-related information or an acknowledgment from the S-SN (operation 406 shown in FIG. 4). The updated full configuration for the measurement-related information may be received if the configuration information is to provide the full configuration. The acknowledgment may be received if the configuration information is to provide the delta configuration.

The function or node may further send the Radio Resource Control (RRC) reconfiguration message to the UE (operation 407 shown in FIG. 4). The RRC reconfiguration message includes configuration of the one or more candidate target PSCells. The configuration may be generated based, at least in part, on the full configuration or the delta configuration received from the T-SN. The function or node may receive the RRC reconfiguration complete message confirming reception of the configuration from the UE (operation 408 shown in FIG. 4). The function or node may confirm that the UE is preparing for SN change by sending a corresponding message to the S-SN (operation 409 shown in FIG. 4).

The function or node may further receive a message indicating execution of the SN change from the UE (operation not shown in FIG. 4; similar operation 210 shown in FIG. 2). The message includes the SN RRC reconfiguration complete message which the function or node sends to the T-SN (operation not shown in FIG. 4; similar operation 211 shown in FIG. 2).

In another example, a function in the cellular wireless communication network or a node such as the T-SN receives, e.g., from the function or node such as the MN as described above, the SN Addition Request message (operation 402 shown in FIG. 4). The SN Addition Request message includes the configuration information based on which the T-SN determines whether to provide a full configuration or a delta configuration for measurement-related information for one or more candidate target PSCells acknowledged by the T-SN. The function or node sends the SN Addition Request Acknowledge message to the MN (operation 404 shown in FIG. 4). The SN Addition Request Acknowledge message includes the full configuration or the delta configuration for measurement-related information for the one or more candidate target PSCells acknowledged by the T-SN, as determined by the T-SN in accordance with the configuration information. The configuration information may comprise an indication that the PSCell change or CPC procedure is initiated by S-SN (SN-initiated indicator). In response to receiving the SN Addition Request message with the SN-initiated indicator, the function or node sends the SN Addition Request Acknowledge message including the full configuration for the measurement-related information. The function or node may further include, in the SN Addition Request Acknowledge message, full configuration or the delta configuration for non-measurement related information for the one or more candidate target PSCells acknowledged by the T-SN.

The indication may also indicate that the PSCell change or CPC procedure was initiated by the MN. The function or node sends the SN Addition Request Acknowledge message including the full configuration for the measurement-related information in response to receiving the SN Addition Request message with the indication that the PSCell change or CPC procedure is initiated by the MN.

The function or node may decide on the one or more candidate target PSCells (operation 403 shown in FIG. 4) using, for example, a list of PSCells selected by the S-SN and received with the SN Addition Request message. The function or node may further generate the full configuration or the delta configuration for the measurement-related information in accordance with the configuration information.

The function or node may further receive, e.g., from the function or node such as the MN as described above, the SN RRC reconfiguration complete message indicating execution of SN change by the UE (operation not shown in FIG. 4; similar operation 211 shown in FIG. 2).

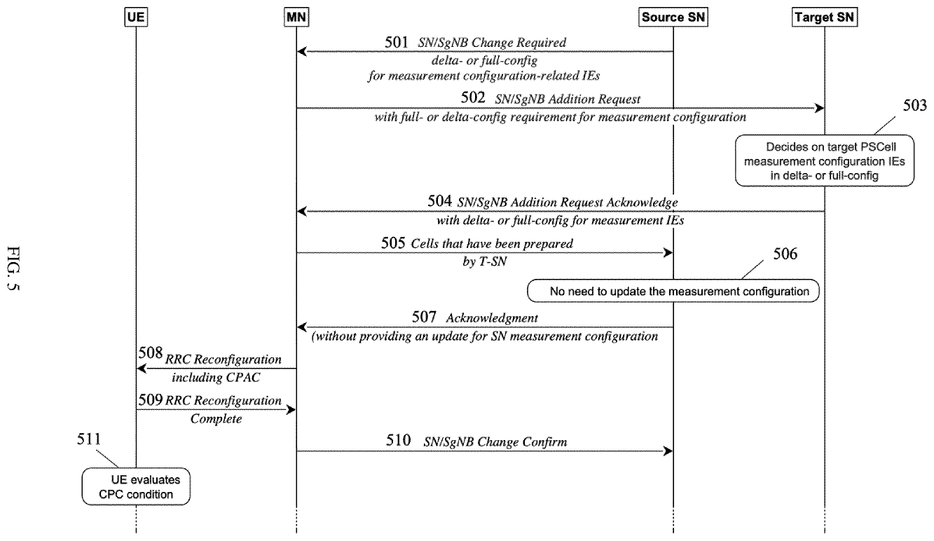

FIG. 5 illustrates a simplified example signaling flow of a method for the Conditional Primary Secondary Cell Group (SCG) Cell (PSCell) change (CPC) procedure with full configuration information according to an example implementation of the present disclosure. The method of FIG. 5 implements the above-described principle and more specifically, concerns the example wherein the configuration information based on which the secondary node (such as the T-SN) determines whether to provide the full configuration or the delta configuration for measurement-related information for one or more candidate target PSCells acknowledged by the node comprises an indication whether the T-SN is to provide the full configuration or the delta configuration. The CPC procedure is SN-initiated.

In operation 501, the MN receives a change required message (i.e., the third message) such as an SN/SgNB Change Required message from the S-SN. The SN Change Required message includes a list of PSCells selected by the S-SN (e.g., based on measurement reports) and CPC execution conditions for all PSCells selected by the S-SN. The operation 501 corresponds to the operation 201 shown in FIG. 2. Further description is therefore omitted. In addition, the change required message further includes an indication whether the T-SN is to provide the full configuration or the delta configuration. The indication is to provide configuration information to the T-SN based on which the T-SN determines to provide full configuration for measurement-related information (e.g., parts, parameters or configuration elements related to measurements) for one or more candidate target PSCells acknowledged by the T-SN. The T-SN needs to use the full configuration for the measurement-related information. That is, when initiating the SN Change procedure, the S-SN informs explicitly if the T-SN is to provide the measurement-related information in full configuration or delta configuration.

In operation 502, the MN requests the T-SN to perform the SN Addition procedure. For example, the MN sends an addition request message (i.e., the first message) such as an SN/SgNB Addition Request message) to the T-SN. The operation 501 corresponds to the operation 201 shown in FIG. 2. Further description is therefore omitted. In addition, the MN sends the addition request message including the indication whether the T-SN is to provide the full configuration or the delta configuration received from the S-SN. For example, the measurement-related information to be provided in the full configuration is related to a measurement configuration of CG configuration-related IE, particularly to at least one of the following parameters: CondReconfigToAddModList, MeasConfig, MeasGapConfig, MeasId, MeasIdleConfig, MeasIdToAddModList.

In operation 503, which is similar to operation 203 shown in FIG. 2, the T-SN decides on the target PSCells (i.e., whether to acknowledge or reject the target PSCells) and generates the configuration for acknowledged PSCells. Different from the description for operation 203, the T-SN generates the measurement-related information of the configuration in full configuration in accordance with the indication received with addition request message, and the remainder in full or delta configuration. For example, the T-SN decides on the target PSCells using the PSCells included in the list of PSCells selected by the S-SN and sent to the T-SN with the addition request message.

In operation 504, the T-SN sends to the MN an addition request acknowledgement message (i.e., the second message) including configuration for each of the target PSCells acknowledged by the T-SN. The target PSCells may be all or a subset of the PSCells included in the list of PSCells selected by the S-SN. Thanks to the indication, the configuration for each of the target PSCells includes the full configuration for the measurement-related information. The configuration may further include non-measurement related information (i.e., the remainder) in full or delta configuration. The non-measurement related information is related to at least one of the following parameters: scg-CellGroupConfig, scg-RB-Config, drx-InfoSCG, selectedBandCombinationNR, candidateServingFreqListNR. The operation 504 corresponds to the operation 204 shown in FIG. 2. Further description is therefore omitted.

In operation 505, the MN informs the S-SN on the list of PSCells acknowledged by the T-SN. For example, the MN sends the list of PSCells to the S-SN. In operation 506, the S-SN analyzes the list to determine whether the configuration (e.g., the SCG configuration of the S-SN) requires updating (e.g., measurement gap removal if inter-frequency PSCell candidates have not been acknowledged). The S-SN performs the update of the configuration (i.e., measurement reconfiguration). As the S-SN receives the full configuration for the acknowledged PSCells via the MN from the T-SN, a risk that the update of the configuration at the S-SN may result in configuration mismatch regarding the configuration prepared by the T-SN in operations 503 and 504 can be avoided. The S-SN provides an updated configuration (i.e., new S-SN measurement configuration) to the MN. If the analysis of the S-SN results in no need to update, the S-SN sends an acknowledgment message to the MN in operation 507, instead of providing the updated configuration.

In operation 508, the MN reconfigures the UE (e.g., by sending the fourth message such as an RRC Reconfiguration message including CPC execution conditions to the UE; the RRC Reconfiguration message may include Conditional PSCell Addition/Change (CPAC)) and, in operation 509, receives the confirmation from the UE (e.g., by receiving the fifth message such as an RRC Reconfiguration Complete message). The successful configuration of the UE for CPC is indicated to S-SN in operation 510. For example, the MN may send a change confirm message (i.e., the sixth message) such as the SN/SgNB Change Confirm message to the S-SN. The UE starts evaluating the CPC execution conditions in operation 511, for example directly after sending the RRC Reconfiguration Complete message in operation 509 or later. The operations 508 to 511 corresponds to the operations 205 to 209 shown in FIG. 2. Further description is therefore omitted.

In some implementations, the SN/SgNB Change Required message sent from the S-SN to the MN may include (at least): identification of one or more T-SNs (e.g., the PCI of each T-SN), SCG configuration (e.g., radio resources, a list of candidate PSCells selected by the S-SN, CPC execution conditions), CPC indication (i.e., indication that the PSCell change procedure is a conditional PSCell change procedure) and delta/full measurement-related parameter configuration indication (i.e., the indication whether the T-SN is to provide the full configuration or the delta configuration). For example, the indication may be an information clement (IE) or a bit, wherein the value of “1” indicates that full configuration is required by the T-SN for measurement-related parameters in the SN/SgNB Addition Request Acknowledge message, while the value of “0” indicates that delta configuration is required. The SN/SgNB Addition Request message sent from the MN to the T-SNs (e.g., using the PCIs included in the SN/SgNB Change Required message) may include (at least): the SCG configuration (e.g., the SCG configuration included in the SN/SgNB Change Required message), the CPC indication (e.g., the CPC indication included in the SN/SgNB Change Required message) and the indication (i.e., the indication as in the SN/SgNB Change Required message). The SN/SgNB Addition Request Acknowledge message prepared by the T-SN and sent from the T-SN to the MN may include (at least): CG configuration for the PSCell acknowledged by the T-SN with full configuration of measurement-related parameters (e.g., measurement gap or measurement ID) and full or delta configuration for non-measurement related parameters. The T-SN decides on the non-measurement related parameters to be provided in full or delta configuration. Furthermore, only a subset of the measurement-related parameters may be provided in full configuration. For example, measurement-related parameters being void or default may be provided in delta configuration. Also, in some implementations, the S-SN may provide configuration information via the MN to the T-SN indicating the measurement-related parameters to be provided in full configuration. The configuration information included in the messages is not limited to the examples described herein.

Still referring to the illustration of FIG. 5, the operations performed by nodes or functions of the cellular wireless communication network, that are involved in the method for the CPC procedure with the indication whether the T-SN is to provide the full configuration or the delta configuration, will be described.

In an example, a function in the cellular wireless communication network or a node such as the MN sends the SN Addition Request message to the T-SN (operation 502 shown in FIG. 5). The SN Addition Request message includes configuration information based on which the T-SN determines whether to provide a full configuration or a delta configuration for measurement-related information for one or more candidate target PSCells acknowledged by the T-SN. The function or node receives the SN Addition Request Acknowledge from the T-SN (operation 504 shown in FIG. 5). The SN Addition Request Acknowledge includes the full configuration or the delta configuration for measurement-related information for the one or more candidate target PSCells acknowledged by the T-SN, as determined by the T-SN in accordance with the configuration information. The SN Addition Request Acknowledge message may further include full configuration or delta configuration for non-measurement related information for the one or more candidate target PSCells acknowledged by the T-SN.

As described above, the configuration information comprises an indication whether the T-SN is to provide the full configuration or the delta configuration for measurement-related information. The function or node receives the SN Addition Request Acknowledge including the full configuration in response to sending the SN Addition Request message with the indication that the T-SN is to provide the full configuration. The function or node receives the SN Addition Request Acknowledge including the delta configuration in response to sending the SN Addition Request message with the indication that the T-SN is to provide the delta configuration.

The function or node may also send configuration information on the one or more target PSCells acknowledged by the T-SN to the S-SN (operation 505 shown in FIG. 5) and receives an updated full configuration for measurement-related information or an acknowledgment from the S-SN (operation 507 shown in FIG. 5). The updated full configuration for the measurement-related information may be received if the configuration information is to provide the full configuration. The acknowledgment may be received if the configuration information is to provide the delta configuration.

The function or node may further send the Radio Resource Control (RRC) reconfiguration message to the UE (operation 508 shown in FIG. 5). The RRC reconfiguration message includes configuration of the one or more candidate target PSCells. The configuration may be generated based, at least in part, on the full configuration or the delta configuration received from the T-SN. The function or node may receive the RRC reconfiguration complete message confirming reception of the configuration from the UE (operation 509 shown in FIG. 5). The function or node may confirm that the UE is preparing for SN change by sending a corresponding message to the S-SN (operation 510 shown in FIG. 5).

The function or node may further receive a message indicating execution of the SN change from the UE (operation not shown in FIG. 5; similar operation 210 shown in FIG. 2). The message includes the SN RRC reconfiguration complete message which the function or node sends to the T-SN (operation not shown in FIG. 5; similar operation 211 shown in FIG. 2).

In another example, a function in the cellular wireless communication network or a node such as the T-SN receives, e.g., from the function or node such as the MN as described above, the SN Addition Request message (operation 502 shown in FIG. 5). The SN Addition Request message includes the configuration information based on which the T-SN determines whether to provide a full configuration or a delta configuration for measurement-related information for one or more candidate target PSCells acknowledged by the T-SN. The function or node sends the SN Addition Request Acknowledge message to the MN (operation 504 shown in FIG. 5). The SN Addition Request Acknowledge message includes the full configuration or the delta configuration for measurement-related information for the one or more candidate target PSCells acknowledged by the T-SN, as determined by the T-SN in accordance with the configuration information. As described above, the configuration information comprises an indication whether the T-SN is to provide the full configuration or the delta configuration for measurement-related information. The function or node sends the SN Addition Request Acknowledge including the full configuration in response to receiving the SN Addition Request message with the indication that the T-SN is to provide the full configuration. The function or node sends the SN Addition Request Acknowledge including the delta configuration in response to receiving the SN Addition Request message with the indication that the T-SN is to provide the delta configuration. The function or node may further include, in the SN Addition Request Acknowledge message, full configuration or the delta configuration for non-measurement related information for the one or more candidate target PSCells acknowledged by the T-SN.

The function or node may decide on the one or more candidate target PSCells (operation 503 shown in FIG. 5) using, for example, a list of PSCells selected by the S-SN and received with the SN Addition Request message. The function or node may further generate the full configuration or the delta configuration for the measurement-related information in accordance with the configuration information.

The function or node may further receive, e.g., from the function or node such as the MN as described above, the SN RRC reconfiguration complete message indicating execution of SN change by the UE (operation not shown in FIG. 5; similar operation 211 shown in FIG. 2).

In yet another example, a function in the cellular wireless communication network or a node such as the S-SN sends, e.g., to the function or node such as the MN as described above, the SN Change Required message (operation 501 shown in FIG. 5). The SN Change Required message includes a list of PSCells selected by the S-SN and configuration information based on which the T-SN determines whether to provide a full configuration or a delta configuration for measurement-related information for one or more candidate target PSCells acknowledged by the T-SN. The SN Change Required message may further include a PSCell change or CPC execution condition for PSCells in the list of PSCells selected by the S-SN. The function or node receives configuration information on the one or more target PSCells acknowledged by the T-SN (operation 505 shown in FIG. 5) and send an updated full configuration for measurement-related information or an acknowledgment (operation 507 shown in FIG. 5). As described above, the configuration information comprises an indication whether the T-SN is to provide the full configuration or the delta configuration for measurement-related information. The function or node may send the updated full configuration for the measurement-related information if the configuration information is to provide the full configuration. The function or node may send the acknowledgment if the configuration information is to provide the delta configuration.

The function or node may further receive, e.g., to the function or node such as the MN as described above, a confirmation that the UE is preparing for SN change (operation 510 shown in FIG. 5).

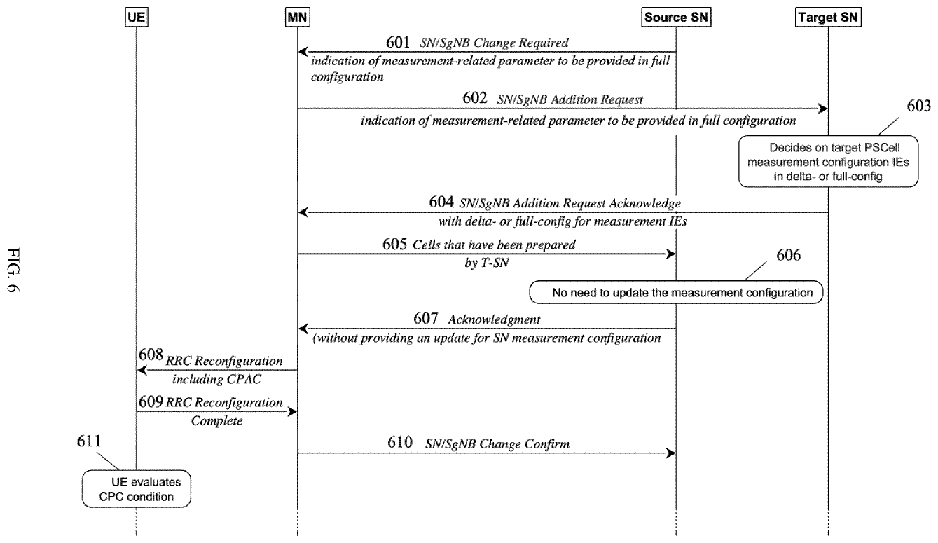

FIG. 6 illustrates a simplified example signaling flow of a method for the Conditional Primary Secondary Cell Group (SCG) Cell (PSCell) change (CPC) procedure with parameter indicator for full configuration information according to an example implementation of the present disclosure. The method of FIG. 6 implements the above-described principle and more specifically, concerns the example wherein the configuration information based on which the secondary node (such as the T-SN) determines whether to provide the full configuration or the delta configuration for measurement-related information for one or more candidate target PSCells acknowledged by the node comprises an indication of at least one (measurement-related) parameter the T-SN is to provide in the full configuration. That is, the configuration information indicates the at least one measurement-related parameter to be provided in the full configuration. The CPC procedure is SN-initiated.

In operation 601, the MN receives a change required message (i.e., the third message) such as an SN/SgNB Change Required message from the S-SN. The SN Change Required message includes a list of PSCells selected by the S-SN (e.g., based on measurement reports) and CPC execution conditions for all PSCells selected by the S-SN. The operation 601 corresponds to the operation 201 shown in FIG. 2. Further description is therefore omitted. In addition, the change required message further includes an indication of at least one measurement-related parameter, or more specifically any parameter, in the configuration for one or more candidate target PSCells acknowledged by the T-SN. The indication is to provide configuration information to the T-SN based on which the T-SN determines to provide full configuration for the measurement-related parameter. The remainder of the configuration for the one or more candidate target PSCells acknowledged by the T-SN is provided in full configuration or delta configuration. That is, when initiating the SN Change procedure, the S-SN selects the parameter that is to be provided by the T-SN in full configuration and informs the T-SN explicitly on the selected parameter.

In operation 602, the MN requests the T-SN to perform the SN Addition procedure. For example, the MN sends an addition request message (i.e., the first message) such as an SN/SgNB Addition Request message) to the T-SN. The operation 601 corresponds to the operation 201 shown in FIG. 2. Further description is therefore omitted. In addition, the MN sent the addition request message including the indication of the parameter to be provided in full configuration, as received from the S-SN. For example, the (measurement-related) parameter to be provided in the full configuration is related to a measurement configuration of CG configuration-related IE, particularly to at least one of the following parameters: CondReconfigToAddModList, MeasConfig, MeasGapConfig, MeasId, MeasIdleConfig, MeasIdToAddModList.

It may be said step 602 is a specific variation of step 502 described above with reference to FIG. 5. In step 502, the MN provides an indication whether the T-SN is to provide the full configuration or the delta configuration received from the S-SN. According to step 602, the MN provides an indication of at least one (measurement-related) parameter among the measurement-related information which is to be provided in full configuration.

In operation 603, which is similar to operation 203 shown in FIG. 2, the T-SN decides on the target PSCells (i.e., whether to acknowledge or reject the target PSCells) and generates the configuration for acknowledged PSCells. Different from the description for operation 203, the T-SN generates the parameter of the configuration in full configuration in accordance with the indication received with addition request message, and the remainder in full or delta configuration. For example, the T-SN decides on the target PSCells using the PSCells included in the list of PSCells selected by the S-SN and sent to the T-SN with the addition request message.

In operation 604, the T-SN sends to the MN an addition request acknowledgement message (i.e., the second message) including configuration for each of the target PSCells acknowledged by the T-SN. The target PSCells may be all or a subset of the PSCells included in the list of PSCells selected by the S-SN. Thanks to the indication, the configuration for each of the target PSCells includes the full configuration for the measurement-related parameter. The configuration may further include other measurement-related parameters or non-measurement related information (i.e., the remainder) in full or delta configuration. The operation 604 corresponds to the operation 204 shown in FIG. 2. Further description is therefore omitted.

In operation 605, the MN informs the S-SN on the list of PSCells acknowledged by the T-SN. For example, the MN sends the list of PSCells to the S-SN. In operation 606, the S-SN analyzes the list to determine whether the configuration (e.g., the SCG configuration of the S-SN) requires updating (e.g., measurement gap removal if inter-frequency PSCell candidates have not been acknowledged). The S-SN performs the update of the configuration (i.e., measurement reconfiguration), if necessary. The S-SN provides an updated configuration (i.e., new S-SN measurement configuration) to the MN. If the analysis of the S-SN results in no need to update, the S-SN sends an acknowledgment message to the MN in operation 607, instead of providing the updated configuration.

In operation 608, the MN reconfigures the UE (e.g., by sending the fourth message such as a RRC Reconfiguration message including CPC execution conditions to the UE; the RRC Reconfiguration message may include Conditional PSCell Addition/Change (CPAC)) and, in operation 609, receives the confirmation from the UE (e.g., by receiving the fifth message such as a RRC Reconfiguration Complete message). The successful configuration of the UE for CPC is indicated to S-SN in operation 610. For example, the MN may send a change confirm message (i.e., the sixth message) such as the SN/SgNB Change Confirm message to the S-SN. The UE starts evaluating the CPC execution conditions in operation 611, for example directly after sending the RRC Reconfiguration Complete message in operation 609 or later. The operations 608 to 611 corresponds to the operations 205 to 209 shown in FIG. 2. Further description is therefore omitted.

In some implementations, the SN/SgNB Change Required message sent from the S-SN to the MN may include (at least): identification of one or more T-SNs (e.g., the PCI of each T-SN), SCG configuration (e.g., radio resources, a list of candidate PSCells selected by the S-SN, CPC execution conditions), CPC indication (i.e., indication that the PSCell change procedure is a conditional PSCell change procedure) and a parameter indication (i.e., the indication indicating at least one parameter such as a measurement-related parameter that is to be provided by the T-SN in the full configuration). For example, the indication may be an information element (IE) indicating the at least one parameter. The SN/SgNB Addition Request message sent from the MN to the T-SNs (e.g., using the PCIs included in the SN/SgNB Change Required message) may include (at least): the SCG configuration (e.g., the SCG configuration included in the SN/SgNB Change Required message), the CPC indication (e.g., the CPC indication included in the SN/SgNB Change Required message) and the parameter indication (i.e., the indication as in the SN/SgNB Change Required message). The SN/SgNB Addition Request Acknowledge message prepared by the T-SN and sent from the T-SN to the MN may include (at least): CG configuration for the PSCell acknowledged by the T-SN with full configuration of the measurement-related parameter indicated by the parameter indication (e.g., measurement gap or measurement ID) and full or delta configuration for other parameters. The T-SN decides on the other parameters to be provided in full or delta configuration.

Still referring to the illustration of FIG. 6, the operations performed by nodes or functions of the cellular wireless communication network, that are involved in the method for the PSCell change or CPC procedure with the indication of at least one parameter the T-SN is to provide in the full configuration, will be described.

In an example, a function in the cellular wireless communication network or a node such as the MN sends the SN Addition Request message to the T-SN (operation 602 shown in FIG. 6). The SN Addition Request message includes configuration information based on which the T-SN determines whether to provide a full configuration or a delta configuration for measurement-related information for one or more candidate target PSCells acknowledged by the T-SN. The function or node receives the SN Addition Request Acknowledge from the T-SN (operation 604 shown in FIG. 6). The SN Addition Request Acknowledge includes the full configuration or the delta configuration for measurement-related information for the one or more candidate target PSCells acknowledged by the T-SN, as determined by the T-SN in accordance with the configuration information.

As described above, the configuration information indicates at least one measurement-related parameter the T-SN is to provide in the full configuration. The function or node receives the SN Addition Request Acknowledge including the full configuration for the at least one measurement-related parameter in response to sending the SN Addition Request message with the indication of the at least one parameter. The SN Addition Request Acknowledge message may further include full configuration or delta configuration for other measurement-related parameters or non-measurement related information for the one or more candidate target PSCells acknowledged by the T-SN.

The function or node may also send configuration information on the one or more target PSCells acknowledged by the T-SN to the S-SN (operation 605 shown in FIG. 6) and receives an updated full configuration for measurement-related information or an acknowledgment from the S-SN (operation 607 shown in FIG. 6). The updated full configuration for the measurement-related information may be received if the configuration information is to provide the full configuration for the at least one parameter. The acknowledgment may be received if there is no need to update.

The function or node may further send the Radio Resource Control (RRC) reconfiguration message to the UE (operation 608 shown in FIG. 6). The RRC reconfiguration message includes configuration of the one or more candidate target PSCells. The configuration may be generated based, at least in part, on the full configuration or the delta configuration received from the T-SN. The function or node may receive the RRC reconfiguration complete message confirming reception of the configuration from the UE (operation 609 shown in FIG. 6). The function or node may confirm that the UE is preparing for SN change by sending a corresponding message to the S-SN (operation 610 shown in FIG. 6).

The function or node may further receive a message indicating execution of the SN change from the UE (operation not shown in FIG. 6; similar operation 210 shown in FIG. 2). The message includes the SN RRC reconfiguration complete message which the function or node sends to the T-SN (operation not shown in FIG. 6; similar operation 211 shown in FIG. 2).

In another example, a function in the cellular wireless communication network or a node such as the T-SN receives, e.g., from the function or node such as the MN as described above, the SN Addition Request message (operation 602 shown in FIG. 6). The SN Addition Request message includes the configuration information based on which the T-SN determines whether to provide a full configuration or a delta configuration for measurement-related information for one or more candidate target PSCells acknowledged by the T-SN. The function or node sends the SN Addition Request Acknowledge message to the MN (operation 604 shown in FIG. 6). The SN Addition Request Acknowledge message includes the full configuration or the delta configuration for measurement-related information for the one or more candidate target PSCells acknowledged by the T-SN, as determined by the T-SN in accordance with the configuration information. As described above, the configuration information comprises an indication of at least one measurement-related parameter the T-SN is to provide in the full configuration. The function or node sends the SN Addition Request Acknowledge including the full configuration for the at least one measurement-related parameter in response to receiving the SN Addition Request message with the indication of the at least one parameter. The function or node may further include, in the SN Addition Request Acknowledge message, full configuration or the delta configuration for other measurement-related parameters or non-measurement related information for the one or more candidate target PSCells acknowledged by the T-SN.

The function or node may decide on the one or more candidate target PSCells (operation 603 shown in FIG. 6) using, for example, a list of PSCells selected by the S-SN and received with the SN Addition Request message. The function or node may further generate the full configuration for the measurement-related parameter in accordance with the configuration information.

The function or node may further receive, e.g., from the function or node such as the MN as described above, the SN RRC reconfiguration complete message indicating execution of SN change by the UE (operation not shown in FIG. 6; similar operation 211 shown in FIG. 2).

In yet another example, a function in the cellular wireless communication network or a node such as the S-SN sends, e.g., to the function or node such as the MN as described above, the SN Change Required message (operation 601 shown in FIG. 6). The SN Change Required message includes a list of PSCells selected by the S-SN and configuration information based on which the T-SN determines whether to provide a full configuration or a delta configuration for measurement-related information for one or more candidate target PSCells acknowledged by the T-SN. The SN Change Required message may further include a PSCell change or CPC execution condition for PSCells in the list of PSCells selected by the S-SN. The function or node receives information on the one or more target PSCells acknowledged by the T-SN (operation 605 shown in FIG. 6) and send an updated full configuration for measurement-related information or an acknowledgment (operation 607 shown in FIG. 6). As described above, the configuration information comprises an indication of at least one measurement-related parameter the T-SN is to provide in the full configuration. The function or node may send the updated full configuration for the measurement-related parameter if the configuration information is to provide the full configuration for the parameter.

The function or node may further receive, e.g., to the function or node such as the MN as described above, a confirmation that the UE is preparing for SN change (operation 610 shown in FIG. 6).

In a variant of the method for the CPC procedure as described above with reference to FIG. 6, the configuration information includes a request to provide configuration for one or more candidate target PSCells to be acknowledged by the T-SN. The request determines for at least a first parameter of the configuration mandatory use of full configuration or optional use of delta configuration, and for at least a second parameter optional use of full or delta. That is, the variation of the method of FIG. 6 also implements the above-described principle and more specifically, concerns the example wherein the configuration information based on which the secondary node (such as the T-SN) determines whether to provide the full configuration or the delta configuration for measurement-related information for one or more candidate target PSCells acknowledged by the node comprises an indication of at least one (measurement-related) parameter the T-SN is to provide in the full configuration. The CPC procedure is SN-initiated.

According to the variant, a first message (e.g., a modification request message such as an SN/SgNB Modification Request message) including a request to provide configuration for one or more candidate target PSCells to be acknowledged by the T-SN is sent from the MN to the T-SN. The request determines for at least a first parameter of the configuration mandatory use of full configuration or optional use of delta configuration, and for at least a second parameter optional use of full or delta configuration. A second message (e.g., a modification request acknowledge message such as an SN/SgNB Modification Request Acknowledge message) including the full configuration or the delta configuration for parameters for the one or more candidate target PSCells acknowledged by the T-SN, is received at the MN from the T-SN in accordance with the request.

Similar to the operation 601 shown in FIG. 6, the MN receives a change required message such (i.e., the third message) as an SN/SgNB Change Required message from the S-SN. The SN Change Required message includes a list of PSCells selected by the S-SN (e.g., based on measurement reports) and CPC execution conditions for all PSCells selected by the S-SN. The change required message further includes a request to provide configuration for one or more candidate target PSCells to be acknowledged by the T-SN, The request determines for at least a first parameter of the configuration mandatory use of full configuration or optional use of delta configuration, and for at least a second parameter optional use of full or delta. Other parameters or the remainder of the configuration for the one or more candidate target PSCells acknowledged by the T-SN may be provided in full configuration or delta configuration. That is, when initiating the SN Change procedure, the S-SN selects the first parameter that is to be provided by the T-SN in full configuration (mandatory use) or delta configuration (optional use), as well as the second parameter that is to be provided in full or delta configuration (optional use).

Similar to the operation 602 shown in FIG. 6, the MN requests the T-SN to perform the SN Addition procedure. For example, the MN sends the first message (i.e., the modification request message such as the SN/SgNB Modification Request message) to the T-SN. In addition, the MN sent the modification request message including the request, as received from the S-SN.

Similar to the operation 603 shown in FIG. 6, the T-SN decides on the target PSCells (i.e., whether to acknowledge or reject the target PSCells) and generates the configuration for acknowledged PSCells. For example, the T-SN generates the full or delta configuration for the parameters in accordance with the request received with addition request message, and the remainder in full or delta configuration.

Similar to the operation 604 shown in FIG. 6, the T-SN sends to the MN the second message (i.e., the modification request acknowledgement message such as the SN Modification Request Acknowledge message) including the full configuration or the delta configuration for parameters for the one or more candidate target PSCells acknowledged by the T-SN.

The further operations of this variant corresponds to the operations shown in FIG. 6. Further description is therefore omitted.

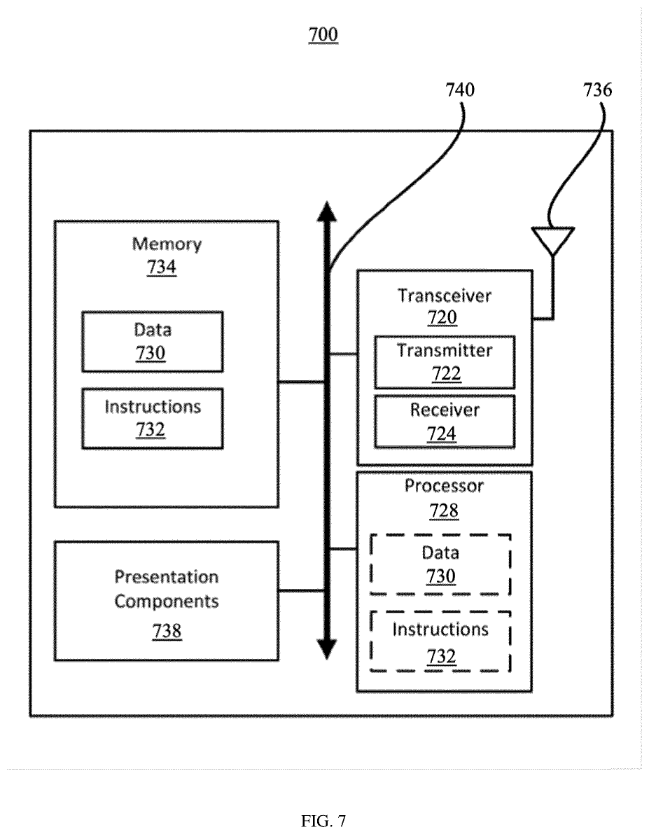

FIG. 7 illustrates a block diagram of a node 700 for wireless communication according to an example implementation of the present disclosure. As illustrated in FIG. 7, a node 700 may include a transceiver 720, a processor 728, a memory 734, one or more presentation components 738, and at least one antenna 736. The node 700 may also include a radio frequency (RF) spectrum band module, a BS communications module, a network communications module, and a system communications management module, Input/Output (I/O) ports, EO components, and a power supply (not illustrated in FIG. 7).

Each of the components may directly or indirectly communicate with each other over one or more buses 740. The node 700 may be an UE or a BS that performs various functions disclosed with reference to FIGS. 1 through 6.

The transceiver 720 has a transmitter 722 (e.g., transmitting/transmission circuitry) and a receiver 724 (e.g., receiving/reception circuitry) and may be configured to transmit and/or receive time and/or frequency resource partitioning information. The transceiver 720 may be configured to transmit in different types of subframes and slots including but not limited to usable, non-usable and flexibly usable subframes and slot formats. The transceiver 720 may be configured to receive data and control channels.

The node 700 may include a variety of computer-readable media. Computer-readable media may be any available media that may be accessed by the node 700 and include both volatile and non-volatile media, and removable and non-removable media.

The computer-readable media may include computer storage media and communication media. Computer storage media may include both volatile and non-volatile media, and removable and non-removable media implemented in any method or technology for storage of information such as computer-readable instructions, data structures, program modules or data.

Computer storage media may include RAM, ROM, EPROM, EEPROM, flash memory or other memory technology, CD-ROM, Digital Versatile Disks (DVD) or other optical disk storage, magnetic cassettes, magnetic tape, magnetic disk storage or other magnetic storage devices. Computer storage media may not include a propagated data signal. Communication media may typically embody computer-readable instructions, data structures, program modules or other data in a modulated data signal such as a carrier wave or other transport mechanism and include any information delivery media.

The term “modulated data signal” means a signal that has one or more of its characteristics set or changed in such a manner as to encode information in the signal. Communication media may include wired media such as a wired network or direct-wired connection, and wireless media such as acoustic, RF, infrared and other wireless media. Combinations of any of the previously listed components should also be included within the scope of computer-readable media.

The memory 734 may include computer-storage media in the form of volatile and/or non-volatile memory. The memory 734 may be removable, non-removable, or a combination thereof. Example memory may include solid-state memory, hard drives, optical-disc drives, etc.

As illustrated in FIG. 7, the memory 734 may store computer-readable, computer-executable instructions 732 (e.g., software codes) that are configured to cause the processor 728 to perform various functions disclosed herein, for example, with reference to FIGS. 1 through 6. Alternatively, the instructions 732 may not be directly executable by the processor 728 but be configured to cause the node 700 (e.g., when compiled and executed) to perform various functions disclosed herein.

The processor 728 (e.g., having processing circuitry) may include an intelligent hardware device, e.g., a Central Processing Unit (CPU), a microcontroller, an ASIC, etc. The processor 728 may include memory. The processor 728 may process the data 730 and the instructions 732 received from the memory 734, and information transmitted and received via the transceiver 720, the baseband communications module, and/or the network communications module. The processor 728 may also process information to be sent to the transceiver 720 for transmission via the antenna 736 to the network communications module for transmission to a core network.

One or more presentation components 738 may present data indications to a person or another device. Examples of presentation components 738 may include a display device, a speaker, a printing component, and a vibrating component, etc.

It should be understood that the node for wireless communication may comprise or be coupled to other units or modules etc., such as radio parts or radio heads, used in or for transmission and/or reception. Although the node has been described as one entity, different modules and memory may be implemented in one or more physical or logical entities.

It is also noted herein that while the above describes exemplary embodiments, there are several variations and modifications which may be made to the disclosed solution without departing from the scope of the present disclosure.

In general, the various exemplary embodiments may be implemented in hardware or special purpose circuits, software, logic or any combination thereof. Some aspects of the present disclosure may be implemented in hardware, while other aspects may be implemented in firmware or software which may be executed by a controller, microprocessor or other computing device, although the present disclosure is not limited thereto. While various aspects of the present disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Example embodiments of the present disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may comprise one or more of general-purpose computers, special purpose computers, microprocessors, digital signal processors (DSPs), application specific integrated circuits (ASICs), FPGA, gate level circuits and processors based on multi-core processor architecture, as non-limiting examples.

Example embodiments of the present disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of the present disclosure. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of the present disclosure as defined in the appended claims. Indeed, there is a further embodiment comprising a combination of one or more embodiments with any of the other embodiments previously discussed.

1-60. (canceled)

61. A method for a Primary Secondary Cell Group (SCG) Cell (PSCell) change procedure, the method comprising:
sending, from a master node (MN) to a target secondary node (T-SN), a first message including configuration information based on which the T-SN determines whether to provide a full configuration or a delta configuration for measurement-related information for one or more candidate target PSCells acknowledged by the T-SN;
receiving, at the MN from the T-SN in accordance with the configuration information, a second message including the full configuration or the delta configuration for measurement-related information for the one or more candidate target PSCells acknowledged by the T-SN.

62. The method of claim 61, wherein the configuration information comprises an indication that the PSCell change procedure is initiated by a source secondary node (S-SN).

63. The method of claim 62, wherein, in response to sending the first message with the indication that the PSCell change procedure is initiated by the S-SN, receiving the second message including the full configuration for measurement-related information.

64. The method of claim 61, wherein the second message further includes full configuration or the delta configuration for non-measurement related information for the one or more candidate target PSCells acknowledged by the T-SN.

65. The method of claim 62, further comprising:
receiving, at the MN from the S-SN, a third message including a list of PSCells selected by the S-SN, wherein the one or more candidate target PSCells being at least a subset of the list of PSCells.

66. The method of claim 65, wherein the third message further includes a PSCell change execution condition for PSCells in the list of PSCells selected by the S-SN.

67. The method of claim 65, further comprising:
in response to receiving the third message from the S-SN, generating, at the MN, the first message with the indication that the PSCell change procedure is initiated by the S-SN.

68. The method of claim 62, wherein the indication comprises an indication whether the PSCell change procedure is initiated by the S-SN or the MN.

69. The method of claim 68, further comprising:
in response to initiating the PSCell change procedure by the MN, generating, at the MN, the first message with the indication that the PSCell change procedure is initiated by the MN.

70. The method of claim 69, wherein, in response to sending the first message with the indication that the PSCell change procedure is initiated by the MN, receiving the second message including the full configuration for measurement-related information.

71. The method of claim 61, wherein the configuration information comprises an indication whether the T-SN is to provide the full configuration or the delta configuration for measurement-related information for one or more candidate target PSCells acknowledged by the T-SN.

72. The method of claim 70, wherein, in response to sending the first message with the indication that the T-SN is to provide the full configuration, receiving the second message including the full configuration, and wherein, in response to sending the first message with the indication that the T-SN is to provide the delta configuration, receiving the second message including the delta configuration.

73. The method of claim 61, wherein the configuration information indicates at least one measurement-related parameter that the T-SN is to provide in the full configuration.

74. The method of claim 73, wherein, in response to sending the first message with the configuration information indicating the at least one measurement-related parameter, receiving the second message including the full configuration of the at least one measurement-related parameter.

75. The method of claim 61, wherein the configuration information including a request to provide configuration for one or more candidate target PSCells to be acknowledged by the T-SN, wherein the request determines for at least a first parameter of the configuration mandatory use of full configuration or optional use of delta configuration, and for at least a second parameter optional use of full or delta.

76. The method of claim 75, wherein, in response to sending the first message with the request, receiving at the MN from the T-SN in accordance with the request, receiving, at the MN from the T-SN in accordance with the request, the second message including the full configuration or the delta configuration for parameters for the one or more candidate target PSCells acknowledged by the T-SN.

77. The method of claim 61, further comprising:
sending, from the MN to the S-SN, configuration information on the one or more target PSCells acknowledged by the T-SN;
receiving, at the MN, from the S-SN, an updated full configuration for measurement-related information or an acknowledgment.

78. The method of claim 61, further comprising:
sending, from the MN to a user equipment (UE), a fourth message including configuration of the one or more candidate target PSCells, the configuration generated based, at least in part, on the full configuration or the delta configuration;
receiving, at the MN from the UE, a sixth message confirming reception of the configuration;
confirming, from the MN to the S-SN, that the UE is preparing for SN change.

79. The method of claim 78, wherein the configuration further includes a PSCell change execution condition for the one or more candidate target PSCells.

80. The method of claim 61, wherein the measurement-related information is related to a measurement configuration of a Cell Croup (CG) Config Information Element (IE).

81. The method of claim 61, wherein the measurement-related information is related to at least one of the following parameters: CondReconfigToAddModList, MeasConfig, MeasGapConfig, MeasId, MeasIdleConfig, MeasIdToAddModList.

82. The method of claim 61, wherein the delta configuration refers to a configuration used in a PSCell of a source secondary node (S-SN).

83. A method for a Primary Secondary Cell Group (SCG) Cell (PSCell) change procedure, the method comprising:
sending, from a master node (MN) to a target secondary node (T-SN), a first message including a request to provide configuration for one or more candidate target PSCells to be acknowledged by the T-SN, wherein the request determines for at least a first parameter of the configuration mandatory use of full configuration or optional use of delta configuration, and for at least a second parameter optional use of full or delta configuration;
receiving, at the MN from the T-SN in accordance with the request, a second message including the full configuration or the delta configuration for parameters for the one or more candidate target PSCells acknowledged by the T-SN.

84. The method of claim 61, wherein the first message is an SN Addition Request message or an SN Modification Request message, and/or wherein the second is an SN Addition Request Acknowledge message or an SN Modification Request Acknowledge message.

85. A method for a Primary Secondary Cell Group (SCG) Cell (PSCell) change procedure, the method comprising:
receiving, at a target secondary node (T-SN) from a master node (MN), a first message including configuration information based on which the T-SN determines whether to provide a full configuration or a delta configuration for measurement-related information for one or more candidate target PSCells acknowledged by the T-SN;
sending, from the T-SN to the MN in accordance with the configuration information, a message including the full configuration or the delta configuration for measurement-related information for the one or more candidate target PSCells acknowledged by the T-SN.

86. The method of claim 85, wherein the configuration information comprises an indication that the PSCell change procedure is initiated by a source secondary node (S-SN).

87. The method of claim 86, wherein, in response to receiving the first message with the indication that the PSCell change procedure is initiated by the S-SN, sending the second message including the full configuration for measurement-related information to the MN.

88. The method of claim 85, wherein the second message further includes full configuration or the delta configuration for non-measurement related information for the one or more candidate target PSCells acknowledged by the T-SN, wherein the T-SN is configured to decide on the full or delta configuration of non-measurement related information.

89. The method of any of claims 88, wherein the non-measurement related information is related to at least one of the following parameters: scg-CellGroupConfig, scg-RB-Config, drx-InfoSCG, selectedBandCombinationNR, candidateServingFreqListNR.

90. The method of claim 86, wherein the one or more candidate target PSCells is at least a subset of the list of PSCells selected by the S-SN.

91. The method of claim 85, wherein the indication comprises an indication whether the PSCell change procedure is initiated by the S-SN or the MN.

92. The method of claim 91, wherein, in response to receiving the first message with the indication that the PSCell change procedure is initiated by the MN, sending the second message including the full configuration.

93. A target secondary node (T-SN), configured to perform the method steps of claim 85.

94. A master node (MN), configured to perform the method steps of claim 83.
